(19) United States
(12) Patent Application Publication
(10) Pub. No.: US 2021/0383377 A1
(43) Pub. Date: Dec. 9, 2021

(54) DECENTRALIZED IDENTITY VERIFICATION PLATFORMS

(71) Applicant: MSHIFT, INC., Newark, CA (US)

(72) Inventors: Xiaomeng ZHOU, Hayward, CA (US); Scott MOELLER, Newark, CA (US); Jacqueline SNELL, Sacramento, CA (US); Andrew YEE, San Francisco, CA (US); David TCHEAU, Redwood City, CA (US); Alan FINKE, Pleasanton, CA (US); Robert OFFICER, Fremont, CA (US)

(21) Appl. No.: 17/111,806

(22) Filed: Dec. 4, 2020

Related U.S. Application Data
(63) Continuation of application No. PCT/US19/38777, filed on Jun. 24, 2019.
(60) Provisional application No. 62/689,016, filed on Jun. 22, 2018.
(60) Provisional application No. 62/802,596, filed on Feb. 7, 2019.

(51) Int. Cl. G06Q 20/38; H04L 9/32; G06Q 20/40; G06Q 20/02

(52) U.S. Cl. CPC G06Q 20/38215; H04L 9/3213; G06Q 20/02; G06Q 20/401; H04L 9/3268

(57) ABSTRACT

Provided are systems and methods for facilitating identity verification using decentralized networks. The systems and methods described herein may allow a user to flexibly control the identity information of the user that is sent to and received by a recipient.

### CROSS-REFERENCE

This application is a continuation of International Application No. PCT/US19/38777, filed Jun. 24, 2019, which claims the benefit of U.S. Provisional Patent Application No. 62/689,016, filed Jun. 22, 2018, and U.S. Provisional Patent Application No. 62/802,596, filed Feb. 7, 2019, each of which applications is entirely incorporated herein by reference.

### BACKGROUND

An increasing number of activities have transitioned from “offline” modalities to “online” modalities with many activities being performed in a hybrid of both modes. For example, individuals may perform a variety of transactions entirely or at least in part “online,” including administrative activities (e.g., scheduling, secretarial, etc.), financial activities (e.g., shopping, banking, gifting, accounting, etc.), creative activities (e.g., posting, commenting, creative writing, etc.), leisure activities (e.g., online gaming, etc.), and others. Some of activities may be performed with varying degrees of disclosure by the individual under aliases, for example, avatars, whether online or offline, such as performing activities or transactions without revealing a true real-world identity of an individual.

### SUMMARY

It is often the case that anonymity is abused when performing certain transactions. For example, an anonymous identification can be used to perform illegal or otherwise unethical activities. In other instances, data is extracted from the presenter that reveals far more information than the presenter sought to convey for the purpose of the interaction. It is difficult to verify (or trust) an identity online, especially where digital files (e.g., of identification) can be forged or manipulated to any degree of precision. It can also be difficult to verify (or trust) an identity offline, such as when an individual does not readily carry an identifying document (e.g., driver's license, passport, tax papers, etc.) or the identifying document, as in the online case, may have been forged or manipulated. An individual whose identity is being verified may also be reluctant to present identifying information to a verifier for fear of diluting personal, and oftentimes highly sensitive or confidential, information, or to have information that was not required for the transaction harvested by the recipient beyond the presenter's intent. Therefore, recognized herein is a need for a trustworthy identity verification platform that can accurately and efficiently verify an identity without revealing information about the individual whose identity is being verified beyond what is needed for the transaction. The identity verification platforms described herein may be used in conjunction with a decentralized network, such as a blockchain network or otherwise a distributed network of computer systems and/or cloud servers. The platforms may be computer implemented.

A transaction involving a user may involve the user verifying its identity with a requester of such identity. Such identity verification may be required, or may be optional. The identity verification platforms described herein may facilitate and achieve, individually or simultaneously, authenticity of a user's identity, anonymity of the identity, and self-sovereignty via a validator that is independent of the user and the requestor. Beneficially, the validator may be able to verify the user's identity to the requestor without having access to details of the transaction, and the validator may not be authorized to provide personal details of the user to the requester unless authorized by the user. A user (e.g., an individual, an entity) may have full control of the user's identity via use of one or more identity avatars.

In an aspect, provided is a method for facilitating identity verification using a decentralized network, comprising: (a) receiving, at a server in communication with a blockchain network, from a recipient a request for a piece of identity information about a sender; (b) based at least on the piece of identity information, providing the sender with a plurality of information profiles containing the piece of identity information; (c) receiving, at the server, from the sender, selection of an information profile from the plurality of information profiles; and (d) retrieving contents of the information profile or a key to the information profile from the blockchain network by an identity service in communication with the sender, and transmitting the contents or information unlocked by the key on the blockchain to the recipient by the identity service via an identity broker in communication with the identity service and the recipient.

In some embodiments, an identity of the sender has been verified by a financial institution in which the sender holds an account.

In some embodiments, wherein an identity of the sender has been verified by an authoritative entity.

In some embodiments, the contents of the information profile have been verified by a trusted third-party.

In some embodiments, the contents of the information profile is in hashed format.

In some embodiments, the hashed format is generated using one or more hash-based message authentication code algorithms.

In another aspect, provided is a method for facilitating identity verification using a decentralized network, comprising: (a) receiving from a first user, at a server in communication with a blockchain network, a broadcast request, wherein the broadcast request comprises a (i) broadcast content, and (ii) a broadcast criteria for recipients of the broadcast request, wherein the blockchain network comprises a smart contract, the smart contract managing access rights to a trusted data store, wherein the trusted data store comprises a plurality of predefined data attributes associated with a plurality of users, and wherein the broadcast criteria comprises a first predefined data attribute of the plurality of predefined data attributes; (b) requesting, by the server, access to the trusted data store by satisfying the smart contract to identify a subset of one or more users of the plurality of users, wherein each user of the subset comprises the first predefined data attribute and satisfies the broadcast criteria; (c) receiving, by the server, identifiers of each user of the subset of one or more users; and (d) broadcasting the broadcast content to the subset of one or more users.

In some embodiments, the broadcast content comprises a digital token.

In some embodiments, the broadcast content comprises information.

In some embodiments, one or more data attributes of the plurality of predefined data attributes has been verified by a verifying entity.

In some embodiments, the verifying entity is a financial institution in which the plurality of users holds an account.

In some embodiments, the verifying entity is an authoritative entity.

In some embodiments, the access rights comprise rights selected from the group consisting of create, read, update, delete, and copy rights.

In some embodiments, the smart contract comprises one or more conditions to process a transaction on the blockchain network. In some embodiments, the one or more conditions comprises satisfying a predetermined signature weight threshold.

In another aspect, provided is a method for facilitating identity verification using a decentralized network, comprising: (a) receiving from a searching user, at a server, input identity data of a user, wherein the user is associated with a master avatar identifier on a blockchain network; (b) hashing the input identity data to generate hashed identity data; (c) using the hashed identity data to search a first set of one or more databases for data that relates to the hashed identity data, wherein the first set of one or more databases is external to the blockchain network; (d) outputting one or more of (1) one or more verifying entity database addresses to one or more verifying entity databases, respectively, and (2) a master avatar address associated with the master avatar identifier on the blockchain network, wherein the one or more verifying entity databases are external to the blockchain network, wherein the one or more verifying entity databases comprise at least a portion of the hashed identity data; and (e) (1) if the one or more verifying entity database addresses are outputted, searching the one or more verifying entity databases, respectively, for data that relates to the hashed identity data, to output personal information of the user, and (2) if the master avatar address is outputted, searching the blockchain network to output a transaction history of the user on the blockchain network.

In some embodiments, the method further comprises outputting one or more of the personal information of the user or the transaction history of the user on the blockchain network on an interface displayed to the searching user.

In some embodiments, the searching user is a verifying entity.

In some embodiments, the input identity data of the user comprises an identifier type and identifier type value.

In another aspect, provided is a method for facilitating identity verification using a decentralized network, comprising: (a) receiving from a searching user, at a server, a master avatar identifier on a blockchain network, wherein the master avatar identifier is associated with a user; (b) using the master avatar identifier to search a first set of one or more databases for data that relates to the master avatar identifier to output one or more of (1) hashed identity data related to the master avatar identifier and one or more verifying entity database addresses to one or more verifying entity databases, respectively, wherein the one or more verifying entity databases are external to the blockchain network, wherein the one or more verifying entity databases comprises at least a portion of the hashed identity data, and (2) a master avatar address associated with the master avatar identifier on the blockchain network, wherein the first set of one or more databases is external to the blockchain network; and (c) (1) if the hashed identity data and one or more verifying entity database addresses are outputted, searching the one or more verifying entity databases, respectively, for data that relates to the hashed identity data, to output personal information of the user, and (2) if the master avatar address is outputted, searching the blockchain network to output a transaction history of the user on the blockchain network.

In some embodiments, the method further comprises outputting one or more of the personal information of the user or the transaction history of the user on the blockchain network on an interface displayed to the searching user.

In some embodiments, the searching user is a verifying entity.

In some embodiments, the input identity data of the user comprises an identifier type and identifier type value.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure.

Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein) of which:

FIG. 1 illustrates a process flow for establishing a user identity in or with a decentralized network.

FIG. 2 illustrates a process flow for exchanging identity information in or with a decentralized network.

FIG. 3 shows a process flow for facilitating payment using graphical codes.

FIG. 4 shows a process flow for facilitating form population on a web-based interface.

FIG. 5 shows a process flow for facilitating validation of log-in credentials on a web-based interface.

FIG. 6 illustrates an example method for creating a master identity profile or master avatar.

FIG. 7 illustrates an example method for creating multiple avatars associated with a master avatar.

FIG. 8 illustrates an example process flow of an identity verification platform.

FIG. 9 illustrates examples of access privileges for a trusted public key data store.

FIG. 10 illustrates another example process flow of an identity verification platform.

FIG. 11 illustrates examples of access privileges for a trusted predefined attributes data unit.

FIG. 12 illustrates an example of an airdrop process flow using an identity verification platform.

FIG. 13 illustrates another example of an airdrop process flow using an identity verification platform.

FIG. 14 illustrates another example of an airdrop process flow using an identity verification platform.

FIG. 15 illustrates an example process flow for creating a searchable broadcast.

FIG. 16 illustrates an example process flow for searching for broadcasts.

FIG. 17 illustrates another example process flow for searching for broadcasts.

FIG. 18 shows computer control systems that are programmed to implement systems and methods of the disclosure.

FIG. 19 illustrates an example process flow for creating a master identity profile or master avatar.

FIG. 20 illustrates an example process flow for creating signed, hashed ID data.

FIG. 21 illustrates an example process flow for verifying signed, hashed ID data.

FIG. 22 illustrates an external database and a verifying entity database in accordance with embodiments of the present disclosure.

FIG. 23 illustrates examples of access privileges for a trusted predefined attributes data unit.

FIG. 24 illustrates example process flows for searching transaction histories of a user based on a real identity.

FIG. 25 illustrates example process flows for searching transaction histories of a user based on an avatar identifier.

FIGS. 26A-26B illustrate example process flows for searching transaction histories of a user based on personal information.

FIG. 27 illustrates other example process flows for searching transaction histories of a user based on personal information.

FIG. 28 illustrates a verifying entity key management system.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Provided herein are systems, methods, and platforms for identity verification that can accurately and efficiently verify an identity of a user to a requester, with multiple levels of hierarchical control, and without revealing unnecessary information about the user whose identity is being verified to a validator (e.g., individual or entity verifying the identity of the individual), at least without the user's authorization. The identity verification platforms described herein may be used in conjunction with a decentralized network, such as a blockchain network. Advantageously, the identity verification platforms described herein can be used or leveraged to provide or facilitate identity verification services. This may be especially beneficial in standardizing identity verification systems and methods, and also obviating the need for duplicative identity verification efforts by a user (e.g., where a user must verify his or her identity, multiple times, with different identity requestors, such as different banks or vendors, often involving cumbersome procedures that require the same or overlapping evidentiary support).

A transaction involving a user may involve the user verifying its identity with a requester of such identity. Such identity verification may be required, or may be optional for the transaction. In some instances, the transaction may involve a broadcast and/or an airdrop, for example, a broadcast of information and/or digital tokens. The identity verification platforms described herein may facilitate and achieve, individually or simultaneously, authenticity of a user's identity, anonymity of the user's identity, and self-sovereignty via a validator that is independent of the transaction. Beneficially, the validator may be able to verify the user's identity to the requestor without having access to details of the transaction, and the validator may not be authorized to provide one or more data attributes associated with the user's identity to the requester unless authorized by the user. A user (e.g., an individual, an entity) may have full control of the user's identity via use of one or more identity avatars.

A real world identity of any user registered in the identity verification platform may be initially verified by an authoritative entity, such as but not limited to an official government entity, a financial institution, an airline company, a rental company (e.g., rental cars, rental furniture, etc.), and/or a retail merchant providing financial services (e.g., issuing credit card with their own brand or co-branded with major credit card company, etc.). Such authoritative entity may be a centralized entity capable of verifying the real world identity of a user, such as via methods or techniques of their own selection (e.g., hard copy documents as evidence, in-person interview, requirement of identification numbers such as the social security number or passport number, etc.). For example, a financial institution (e.g., bank, insurance company, stock exchange, brokerage, etc.) may require and verify personal information of a user that receives financial services from such institution. An airline company may require and verify personal information of a user (e.g., legal name, sex, date of birth, etc.) to register the user as a frequent user (e.g., frequent flier). A user who completes at least one travel may have their identity verified by the airline company and/or the relevant government authorities (e.g., transportation security administration (TSA) or border control authorities, etc.). A rental company (e.g., rental car company) may require and verify identification documents (e.g., driver license, credit card information, etc.) from a user receiving rental services from such company. A retail merchant providing financial services (e.g., issuing credit card with their own brand or co-branded with a major credit card company) may perform the same or similar identity verification procedures as financial institutions. The real world identity of a user may be verified via an account with the authoritative entity. In some instances, the authoritative entity may be a higher education institution, such as a college or university that independent verifies the real world identity of a user. In some instances, the central entity may verify a real world identity of a user by receiving hashed information from the authoritative entity, wherein the hashed information is accessible only by the authoritative entity and/or the user.

A user can refer to a consumer, a merchant, a transferor, a transferee, a sender, a recipient, and/or any party to a fund transfer or other financial transaction. A user can be an individual or entity capable of legally owning financial property, such as an account, with financial institutions. A user can be an individual or entity capable of owning property, such as money. A user can be an individual or entity capable of depositing, withdrawing, entrusting, and/or storing, such property with financial institutions. For example, a user can be a legal entity (e.g., corporation, partnership, company, LLC, LLLC, etc.). A user can be a government or government entity. A user can be an individual or entity capable of initiating, sending, receiving, and/or approving a financial transfer or financial transaction.

A financial institution (FI) can refer to a deposit-taking institution, such as a bank, building society, credit union, trust company, brokerage, mortgage loan company, or other loan companies. In some instances, a financial institution can be an insurance company, trust company, pension fund, broker, underwriter, investment fund, or other institutions or entities dealing with financial transactions. In some instances, a financial institution may be an exchange or trade, such as a stock exchange, securities exchange, or cryptocurrency exchange. Any description herein of a bank may apply to any other type of financial institution. A financial institution can allow a user to have or manipulate (e.g., buy, sell, trade, exchange, etc.) financial property, such as an account or a trust, with or entrusted to the financial institution. Such accounts or trusts can contain money, funds, or other tangible or intangible objects of positive (e.g., credit) or negative (e.g., debit, loans, etc.) financial value. An account can be a demand deposit account (DDA), checking account, savings account, line of credit account, loan account or other type of account. An accountholder at a bank can have a plurality of the same or different accounts at the bank. A plurality of accountholders can share a single account.

Users of the identification verification platform described herein may have their physical-world identities verified by a financial institution (e.g., bank) via an existing account (e.g., DDA) of the user with the financial institution. The existence of the account may inherently verify the existence and legal standing of the user, as the financial institution is likely to have already performed a strict identity verification process for compliance with regulations (e.g., Know Your Customer (KYC) regulations, Anti-Money Laundering (AML) regulations). The physical-world identities may be verified by other authoritative entities, as described elsewhere herein.

Each user of the platform may be assigned a unique user identifier (ID) based at least in part on the verified real-world identities. For example, this may prevent a user from having more than one unique user ID, which can be beneficial for modulating and preventing duplicate transactions and/or creation of duplicate or inconsistent records. Beneficially, such verification methods allow existing financial infrastructure (e.g., centralized financial institutions) to remain an integral part of an otherwise decentralized network of identities. Furthermore, such unique user IDs may be used to track the real-world identities, such as when required by law (e.g., pursuant to government warrants), and can shift the burden of responsibility from the identity verification platform to the actual individual actors.

Provided are decentralized networks, such as a blockchain, that can be used to facilitate one or more transactions involving a user by validating and recording the one or more transactions on the blockchain. Personal identifying information of users may be stored external to the decentralized network (e.g., blockchain) to maintain the anonymity of individuals. Such external storage may maintain the sovereignty of the users' identity from the blockchain and its other participants, such that control of the user's personal identifying information, which makes up the user's electronic identity, is maintained by the user.

The platform may address privacy concerns by allowing individuals to control the amount or type of information that is revealed for a particular type of identity verification. For example, user real IDs (e.g., driver's license, passport) and/or sensitive identifying information may be revealed to a recipient only with the sender's consent. A single user may construct a plurality of different identity profiles, for example, avatars, to share with different classes of recipients needing different levels of identity verification, with all levels of identity being generated by the individual user. For example, a vendor selling alcohol may require a stricter level of identity verification (e.g., including age and picture) than a vendor merely trying to prevent duplicate coupon use (e.g., uniqueness of user IDs).

A user's full identity profile may comprise a set of distinct data attributes. A first subset of such data attributes may be combined to construct a first identity profile, or first avatar, of the user. A second subset of data attributes, e.g., different from the first subset, may be combined to construct a second identity profile. The first and second identity profiles may be used for different types of identity verification, as described elsewhere herein. A user may construct any number of different identity profiles, which may comprise different subsets of data attributes. For example, a user may construct at least about 1, 2, 3, 4, 5, 6, 7, 8, 9, 10, 20, 30, 40, 50, 60, 70, 80, 90, 100 or more identity profiles. Alternatively or in addition, a user may construct at most about 100, 90, 80, 70, 60, 50, 40, 30, 20, 10, 9, 8, 7, 6, 5, 4, 3, or 2 identity profiles. A subset of data attribute may comprise any number and any combination of data attributes. For example, a subset of data attributes may comprise all data attributes. For example, a subset of data attributes may comprise no data attributes. For example, a subset of data attributes may comprise at least about 1, 2, 3, 4, 5, 6, 7, 8, 9, 10, 20, 30, 40, 50, 60, 70, 80, 90, 100 or more data attributes. Alternatively or in addition, a subset of data attributes may comprise at most about 100, 90, 80, 70, 60, 50, 40, 30, 20, 10, 9, 8, 7, 6, 5, 4, 3, or 2 data attributes.

Avatars described herein may identified as a ‘master’ avatar, which is uniquely associated with a user whose identity has been verified, or a ‘subset’ avatar, which may comprise a subset of predefined data attributes of a user's identity. A ‘master’ avatar may be associated with a plurality of ‘subset’ avatars. Different identity profiles (e.g., avatars) may be used for different types of identity verification. As non-limiting examples, one subset avatar is used generated for use in purely anonymous transactions, which only provides confirmation of a payment, enabling the individual to use a digital token or cryptocurrency as a form of digital cash. In another example, another subset avatar is generated to contain the individual's preferred shipping address, email, and phone number for the purpose of automatically and securely filling out shipping information on a variety of websites. In some instances, such digital, authenticated, identity profiles may further obviate the need for human-bot discrimination screens (e.g., Captchas) to complete an online action.

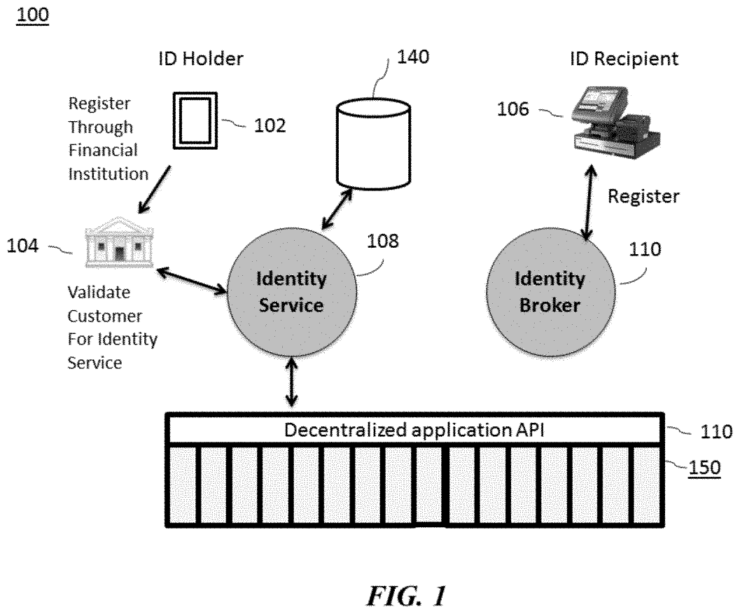

FIG. 1 illustrates a process flow for establishing a user identity for use in or with a decentralized network. A user (or ID holder), having or associated with user device 102, may register with an identity verification platform 100 via a financial institution 104, such as by creating an account (e.g., DDA) with the financial institution 104. The financial institution 104 may validate the identity of the user via the existing account to an identity service 108. Once the identity of the user is verified with the identity service 108, the identity service 108 may establish the user identity in a decentralized network 150, such as by providing the user with an account for use on the blockchain in the decentralized network 150. The user may be assigned an identifier (ID) for use in the decentralized network (e.g., blockchain). Each user of the blockchain may be assigned a unique user ID. User information, including one or more data attributes, forming the user identity may be stored in a database 140 that is external to the decentralized network 150. The account may be used for transactions associated with the blockchain, such as performing financial transactions (e.g., paying), receiving tokens (e.g., rewards), and interacting with other accounts of users who have been verified in the decentralized network 150.

The identity service 108 may communicate with the decentralized network 150 via a decentralized application API 110.

The identity service 108 can store and retrieve specific user data about the user in the database 140. The database 140 may comprise one or more databases. In some instances, the one or more databases may comprise a trusted data store. The one or more databases may comprise data units for storing, for example, trusted predefined attributes of users and trusted public keys. Specific user data can be provided to a recipient if the user agrees to share that information with the recipient. For instance, the database may store hashed or encrypted user data for the user account. User data can include personal information (e.g., full name, previous names, address, phone number, email address, social security number, etc.), employment information (e.g., employer name, employer address, work email, work phone number, years of employment, etc.), financial information (e.g., credit card number, bank name, bank account number, routing number, Paypal® account, etc.), online profile information (e.g., username, nickname, password, security question & answer, etc.), and sometimes copies of physical documents (e.g., driver's license, transcript, statement, utility bill, etc.). User data may also include custom fields generated by the user or requested by the recipient. The user may provide a subset of such user data to a recipient. The database may also store information about the user that has been verified by trusted third parties. For instance, the DMV may attest that a user is over 21 years of age, and a university may verify degrees or certifications that a user has received. The blockchain 150 may store keys that may unlock data stored elsewhere, such as the database 140. For example, the blockchain itself may not store any sensitive information such as medical records, but may store a cryptographic key that can be used to retrieve the data from a trusted third-party.

A recipient (or ID recipient), having or associated with user device 106, that wants to verify the identity of the user may register with an identity broker 110. The identity service 108 may discover the correct identity broker 110 (from a plurality of identity brokers) at the time of transaction, to allow the identity broker 110 to verify the user's identity and request any additional information from the user (or form user device 102), such as specific user data. In an example, the recipient may request shipping information for a customer user to the identity broker 110, which may communicate the request to the identity service 108, which may verify with the customer user whether or not to provide the requested shipping information to the recipient. Similarly, the identity service 108 may discover the identity broker 110 in order to push information to the recipient. In some instances, the identity service 108 may comprise the identity broker 110. In some instances, the identity service 108 and the identity broker 110 may be, or may be part of, the same entity such that any interactions (e.g., discovery, communication, etc.) between the two, as described elsewhere herein, are internal to the entity and/or the need for such interactions obviated (as they are the same entity).

The different entities and/or devices may communicate over a network (not shown). The network may comprise one or more networks that connect devices and/or components in the network to allow communication between the devices and/or components. For example, the network may be implemented as the Internet, intranet, extranet, a wireless network, a wired network, a local area network (LAN), a Wide Area Network (WANs), Bluetooth, Near Field Communication (NFC), meshnet, or any other type of network that provides communications between one or more components of the network layout. In some embodiments, the network may be implemented using cell and/or pager networks, satellite, licensed radio, or a combination of licensed and unlicensed radio. The network may be wireless, wired (e.g., Ethernet), or a combination thereof. Systems and devices communicating via the network may communicate via one or more network adaptors and/or communication interfaces. The network can span across state or sovereign boundaries, such that a first entity and/or device located in a first sovereign state can communicate with a second entity and/or device located in a second sovereign state.

The user devices 102, 106 may be an electronic device. For example, the user devices may each be a mobile device (e.g., smartphone, tablet, pager, personal digital assistant (PDA)), a computer (e.g., laptop computer, desktop computer, server), and/or a wearable device (e.g., smartwatches). A user device can also include any other media content player, for example, a set-top box, a television set, a video game system, or any electronic device capable of providing or rendering data. For example, a user device can be a credit card processing machine or card reader. The user device may optionally be portable. The user device may be handheld. The user device may be a network device capable of connecting to a network, such as described previously, or other networks such as a local area network (LAN), wide area network (WAN) such as the Internet, intranet, extranet, a telecommunications network, a data network, and/or any other type of network. The user device may also be a hardware device designed specifically for identity functionality like that of a card key.

A user device may each comprise memory storage units which may comprise non-transitory computer readable medium comprising code, logic, or instructions for performing one or more steps. A user device may comprise one or more processors capable of executing one or more steps, for instance in accordance with the non-transitory computer readable media. The user device may comprise a display showing a graphical user interface (GUI). The user device may be capable of accepting inputs via a user interactive device. Examples of such user interactive devices may include a keyboard, button, mouse, touchscreen, touchpad, joystick, trackball, camera, microphone, motion sensor, heat sensor, inertial sensor, or any other type of user interactive device. For example, a user may input identity verification requests, approvals, or denials to the system 100 via one or more user interactive devices. The user device may be capable of executing software or applications provided by one or more systems (e.g., financial institution 110, platform 100, etc.). One or more applications may be related to identity verification, fund transfer, payment processing, or financial transactions. One or more applications and/or software may be implemented in conjunction with a user interface on a GUI. For example, the user interface can be a mobile-based interface and/or a web-based interface. The user interface may be as simple as a single LED light.

A user device may comprise one or more sensors. For example, a user device may comprise one or more geo-location sensors that may be useful for detecting the location of the user device. For example, the geo-location sensors may use triangulation methods or global positioning systems (GPS) to aid in determining a location of the computing device. For example, one or more cell towers can use triangulation methods to locate a user device emitting or transmitting signals. A user device may comprise an image capture device or other optical sensor (e.g., camera) and be capable of capturing an image and/or reading an image (e.g., a code, text, etc.). For example, a camera can be integrated in the user device. The camera can be an external device to the user device and communicate via wired (e.g., cable) or wireless (e.g., Bluetooth, Wi-Fi, NFC, etc.) connection. The image capture device may be useful for capturing an image of the user or any other object within the user's environment. In some instances, the user device may receive or access one or more images captured by an external device in the external device memory, user device memory, and/or a separate storage space, including a database of a server or a cloud storage space or from an identifier stored on a blockchain. A user device may comprise a beacon (e.g., Bluetooth beacon) that is configured to broadcast an identifier or other data to nearby electronic devices. A user device may comprise an electronic display capable of displaying a graphical user interface.

The user device may be, for example, one or more computing devices configured to perform one or more operations consistent with the disclosed embodiments. In some instances, the software and/or applications may allow users to register with the platform 100, register with the financial institution 104, register with the identity service 108, register with the identity broker 110, transmit and/or receive requests, commands, or instructions relating to identity verification and/or financial transactions, detect a location of the user device, broadcast an identifier or other data, transmit, receive, and/or process data, capture an image, read an image, such as read text via one or more optical character recognition (OCR) algorithms or read a code via one or more decrypting or decoding algorithms, and/or display an image.

The platform 100 may communicate with one or more users or entities (e.g., ID holder, ID recipient, identity service, identity broker etc.) via the network to coordinate one or more identity verification transactions from, to, and/or between the one or more users or entities. In some instances, the platform 100 may be configured to reliably identify an individual user (internally with the platform 100) and authenticate the identified individual before accepting a user command or instruction (e.g., identity verification instruction). To accomplish this, the platform may be programmed with (or otherwise store in memory instructions to implement) software and/or application to authenticate a user by requesting unique user credentials (e.g., PIN, passcode, password, username, cryptographic proof, etc.) and verifying identification. In some instances, the platform may be in communication with hardware, for example, a biometric reader, for distinguishing the identity of the authorized user from an impostor. The biometric reader may require an enrollment step, methods, and hardware for acquiring the biometric data, and methods for comparing the biometric data that is acquired with the biometric data that the user enrolled with. A biometric reader used in this capacity may have thresholds for determining whether a biometric reading falls within the acceptable confidence range of the enrolled content. In some instances a biometric reader of this type may have built-in controls that prevent the biometric reader from being tampered with, should an impostor wish to use unintended means for accessing or authorizing sharing of the content. In some instances, the platform may communicate with an external device comprising the biometric reader. For example, user devices 102 and 106 can comprise biometric readers (e.g., sensors for fingerprints, retina, audio, facial recognition etc.) communicating with the platform 100.

The platform 100 and/or user devices 102, 106 of the users can individually or collectively comprise a biometric module for collecting, storing, processing, translating or analyzing biometric data. Biometric data may include any feature or output of an organism that can be measured and used to uniquely identify the organism. Biometric data may include, but are not be limited to, fingerprints, DNA, body temperature, facial features, hand features, retina features, ear features, and behavioral characteristics such as typing rhythm, gait, gestures and voice. The biometric module may receive data from biometric readers, for example, a fingerprint reader or retinal scanner, optical sensors, microprocessors, and RAM/ROM memory. Software components of the biometric module may comprise one or more software-based programs, including applications, protocols, or plugins, configured for collecting and/or processing biometric data from the hardware components of the biometric module. In some instances, collection and processing biometric data may comprise operations for analyzing the biometric data, creating a template (i.e. digital template) for biometric data, storing, matching, and verifying the biometric data (i.e. with an external database or previously stored information). In some embodiments a biometric reader may also be coupled to a user device through wired or wireless approaches. Wireless approaches may include one or more types of Wi-Fi or peer-to-peer (P2P) networking protocols. In other embodiments a biometric reader may be built into the web-enabled device. In some embodiments, the biometric module may be included, installed, or attached to the user device.

The platform 100 may comprise one or more servers to perform some or all operations of the platform 100, as described herein. A server, as the term is used herein, may refer generally to a multi-user computer that provides a service (e.g. validation, etc.) or resources (e.g. file space) over a network connection. The server may be provided or administered by an online service provider or administrator. In some cases, the server may be provided or administered by a third party entity in connection with a device provider. Any description of a server herein can apply to multiple servers or other infrastructures. For example, one or more servers can collectively or individually perform the operations of the platform 100 disclosed herein. In some instances, the server may include a web server, an enterprise server, a database server, or any other type of computer server, and can be computer-programmed to accept requests (e.g., HTTP, or other protocols that can initiate data transmission) from a computing device (e.g., a user device, a public share device) and to serve the computing device with requested data. In addition, the server can be a broadcasting facility, such as free-to-air, cable, satellite, and other broadcasting facility, for distributing data. The server may also be a server in a data network (e.g., a cloud computing network, peer-to-peer configuration, etc.).

In some embodiments, the online service provider of the platform 100 may administer one or more servers to provide various services to users of the system. While some disclosed embodiments may be implemented on the server, the disclosed embodiments are not so limited. For instance, in some embodiments, other devices (such as one or more user devices of the users) or systems (such as one or more financial institutions, identity services, identity brokers) may be configured to perform one or more of the processes and functionalities consistent with the disclosed embodiments, including embodiments described with respect to the server.

The server of platform 100 may comprise and/or be in communication with one or more databases, such as the database 140 and the blockchain network 150. The blockchain network 150 may be a distributed ledger enabling the storage of data records as unique blocks connected by one or more secure links. The blockchain network may be cryptographically secured. A given block in a blockchain network may associate transaction data with a timestamp. In the blockchain network, duplicate data can be recorded as unique blocks instead of as identical copies of data. A given block may comprise data of a previous block to the given block (e.g., wherein the data of the previous block is hashed), making the blockchain network essentially immutable, as data once recorded in a block in the distributed ledger cannot be modified or removed without triggering inconsistency with the linked blocks. This immutable property can provide particular benefits to recording identity verification transactions or otherwise processing information exchange, such as to prevent forgery or other frauds in identification verifications and recording liability of identity verifications, as appropriate. The blockchain network may comprise one or more smart contracts, as described elsewhere herein.

The blockchain network 150 may be stored in one or more nodes. The one or more nodes may be distributed in one or more computer systems or devices, such as those described herein (e.g., 102, 106, etc.). When the blockchain network is updated, such as by one of the nodes in the one or more nodes, it may be updated in each node of the one or more nodes, such as via a network.

A user (e.g., ID holder) may be registered to the platform 100, such as via creating an online account (or otherwise establishing the user's identity as described elsewhere herein) with a server of the platform 100. In some instances, only registered users may be provided with one or more services of the platform 100. In other instances, any user, registered or not, may be provided with one or more services of the platform. For example, an unregistered user can be capable of receiving identity information about a registered user. A registered user may be able to provide identity verification information to a registered recipient or an unregistered recipient.

In some instances, the platform 100 can be used in conjunction with any other systems and/or servers (e.g., hosting a site, website, forum, blog, etc.) through which a user can initiate or become party to a transaction. The platform can be used with a plurality of other systems and/or servers. For example, the platform can communicate with or be integrated in an independent system (e.g., web-based interface) hosted by a user (e.g., ID holder, ID recipient) or an entity (identity service 108, identity broker 110). The transfers described herein can be implemented and/or initiated, individually or collectively, by the one or more systems described herein. For example, an application and/or software deployed or administered by one system (e.g., platform 100, financial institution 104, identity service 108, identity broker 110) can be integrated or incorporated into an application and/or software deployed or administered by another system and/or into hardware devices (e.g., user devices). The application and/or software can be deployed or administered by an intermediary entity. Alternatively or in addition, an application and/or software can be provided as a standalone application. Alternatively or in addition, an application and/or software can be integrated or incorporated into other applications or hardware devices.

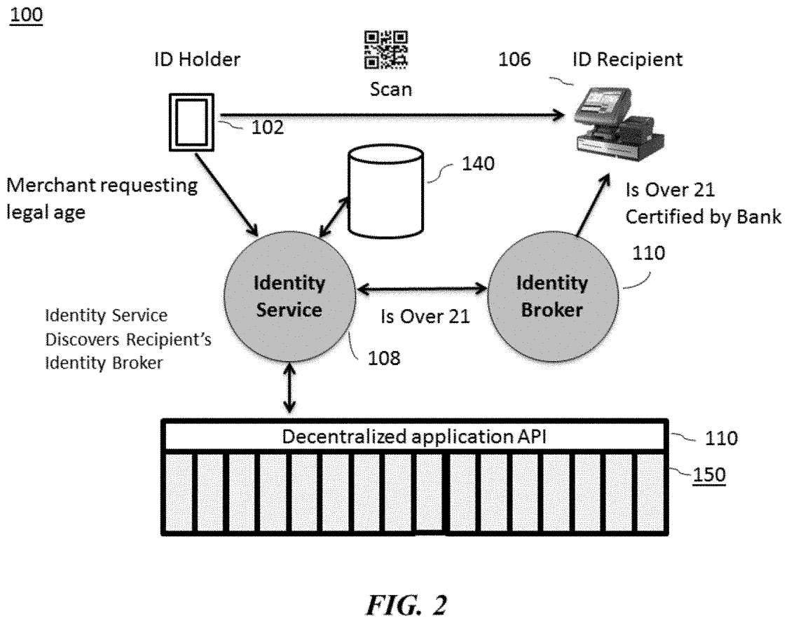

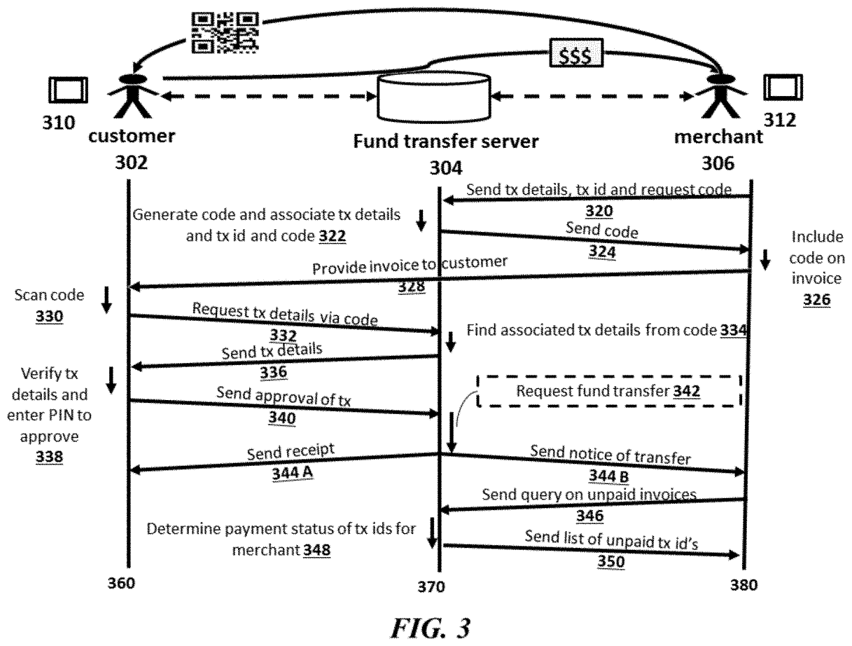

FIG. 2 illustrates a process flow for exchanging identity information for a transaction in or with a decentralized network. A first user (ID holder) may wish to initiate a fund transfer to a second user (ID recipient), such as to purchase an object (e.g., alcohol) that has an associated threshold legal age (e.g., 21 years old). Such transactions may be initiated and/or requested with aid of a graphical code, such as a quick response (QR) code. Further details on graphical code-aided financial transaction are provided with respect to FIG. 3. The QR code can be associated with both a financial transaction and an information transaction. Alternatively, separate QR codes can be provided for the different transactions (e.g., financial transactions, information transactions, etc.). Alternatively, such identity verification request may be made independent of any fund transfer. As an example, where the first user is an interviewee and the second user is an interviewer, the second user may request resume data (e.g., employment information, education information, etc.) from the first user without a fund transfer.

The graphical code can be a visual graphical barcode of any format, such as a bar code, text, a picture, a sequence thereof, or the like that can be captured and/or displayed on a device. The visual graphical barcode may be a two-dimensional barcode, such as PDF417, Aztec, MaxiCode, and QR code, etc. The visual graphical barcode may be a one-dimensional barcode, such as Interleaved 2/5, Industrial 2/5, Code 39, Code 39 Extended, Codabar, Code 11, Code 128, Code 128 Extended, EAN/UCC 128, UCC/EAN-128, UPC-E, UPC-A, EAN-8, EAN-13, Code 93, Code 93 Extended, DataBar Omnidirectional (RSS-14), DataBar Truncated (RSS-14 Truncated), DataBar Limited (RSS Limited), DataBar Stacked, DataBar Expanded, and DataBar Expanded Stacked, etc. The visual graphical barcode can encode various types of information in any type of suitable format, such as binary, alphanumeric, ASCII, and other formats, and the code can be based on any standards. The visual graphical barcode may have various storage capacities that can encode a certain amount of data, and variable physical size. In some embodiments, the visual graphical barcode may conform to known standards that can be read by standard barcode readers. In other embodiments, the visual graphical barcode may be proprietary such that it can be read only by an authenticated application provided by an authentication system running on a user device. In some instances, only a system or proprietary application and/or software deployed by the system can be capable of encrypting/decrypting the visual graphical barcode. The visual graphical barcode can be a one-dimensional barcode, two-dimensional barcode or three-dimensional barcode. The visual graphical barcode can be, for example, one-dimensional barcode that includes linear patterns such as lines and spaces. The lines and spaces may be black-and-white. The lines and spaces can comprise more than one color. The color may be visible to human eyes. The color of the barcode may be distinguishable by special tools. For instance, the barcode may include print carbon lines which are detectable using an infrared scanner. The visual graphical barcode can be a two-dimensional barcode including various shapes. The visual graphical barcode may be static or dynamic. The visual graphical barcode may be changed or updated at a certain frequency. The frequency may vary widely in range, such as from 100 Hz to 0.001 Hz. Any description herein of a QR code can be applicable to any visual graphical barcode, and vice versa.

The second user may request age information of the first user. Alternatively, the first user may volunteer such age information. In either case, the platform server may provide a QR code representing the information transaction (e.g., request for first user's age). The QR code may be displayed by the user device 102 and/or the user device 106. The first user may scan the QR code, such as using the user device 102, and, in response, the platform 100 may direct the first user's identity service 108 to locate the second user's identity broker 110 to determine if any additional information is requested by the second user. Upon confirming that additional information is requested (e.g., legal age), the first user's identity service 108 may communicate with the server to send the first user payment information (relating to the financial transaction) and the second user's request for age verification (relating to the information transaction). The first user may approve the purchase. The first user may approve the request for age verification, such as by explicitly approving the request for information and/or by selecting a user profile of the first user that comprises the legal age information. Upon approval, the identity service 108 may retrieve the requested information or the user profile from the database 140, such as by using a key associated with the first user that is stored on the network 150, and transmit the information to the identity broker 110, which may inform the second user of the requested information. In some instances, the information requested may query a binary answer (e.g., T/F, 0/1, Y/N, etc.), and the platform 100, identity service 108, and/or the identity broker 110 may process the user data in the account of the first user to determine such binary answer without retrieving the actual data value (e.g., legal age: 37). In some instances, the information requested can be a cryptographic key from the network 150 that can be used to unlock information stored in a separate trusted database (e.g., database 140).

FIG. 3 shows a process flow for facilitating payment using graphical codes. In FIG. 3, the process(es) carried out by or involving a customer 302 (e.g., who may correspond to first user in FIG. 2) are represented by a contact with a vertical line 360, the process(es) carried out by or involving a fund transfer server 304 are represented by a contact with a vertical line 370, and the process(es) carried out by or involving an intended recipient 306 (e.g., who may correspond to the second user in FIG. 2) are represented by a contact with a vertical line 380.

A customer 302 can process a payment to a merchant 306 with aid of a fund transfer server 304. The merchant may send an invoice to the customer with aid of the fund transfer server. The customer may process the payment and/or communicate with the server with aid of a first user device 310, and the merchant may send the invoice and/or communicate with the server with aid of a second user device 312. The user devices can correspond to the user device 102 and 106 of FIGS. 1-2.

When the customer 302 has unpaid dues to the merchant 306, for example, for purchase of goods or services form the merchant, the merchant can decide to send the customer an invoice. The invoice can be a paper invoice that is physically delivered or tendered to the customer. The invoice can be an electronic invoice that is electronically delivered, such as over a computer network. The invoice delivered to the customer can contain a QR code or other visual graphical indicia encoding information related to the invoice. The visual graphical indicia can be a visual graphical barcode of any format, such as described elsewhere herein.

The merchant 306 can send 320 a QR code request to the fund transfer server 304. The QR code request can include information such as transaction details, a transaction identification number (ID) or any other information related to one or more transactions to be included in the invoice. For example, the QR code request can include at least all information that is printed on or included on the face of the invoice. Upon receipt of the QR code request from the merchant, the fund transfer server can generate 322 a QR code. The QR code can encode such transaction information provided by the merchant (e.g., transaction details, transaction ID, and/or any information related to one or more transactions to be included in the invoice, etc.). The fund transfer server can otherwise associate such transaction information to the QR code. The server can store such association information in memory, such as in a database. The server can send 324 the QR code to the merchant. Upon receipt of the QR code, the merchant can include 326 the QR code on the invoice to be sent to the customer. For example, the QR code can be printed on a paper invoice. In another example, the QR code can be attached or included in an electronic invoice. Alternatively or in addition, the fund transfer server can generate and send the merchant a code (e.g., alphanumeric code) or other data that the merchant can use to self-generate the QR code, and this code or other data can be associated with the transaction information in a database of the server.

The merchant 306 can then provide 328 the invoice with the QR code to the customer 302. In some instances, a paper invoice can be physically delivered or tended to the customer. In some instances, an electronic invoice can be electronically delivered to the customer, such as over a computer network. In some instances, an electronic invoice can be electronically delivered to the customer via the fund transfer server 304. In some instances, an electronic invoice can be displayed to the customer 302 over a display. For example, the electronic invoice can be displayed on a display provided by the merchant 306 or a display of the customer 302 (e.g., of a user device). The display may be, or be part of, a processing device (e.g., purchase processing device, cash register, etc.), a personal device (e.g., mobile phone, tablet, computer, monitor, etc.), or other device. Upon receipt of the invoice by the customer, the customer can use an optical sensor of the user device 310 to scan 330 the QR code on the invoice. In some instances, the user device 310 may execute scanning or optical recognition algorithms to identify, recognize, and/or scan a QR code from an electronic invoice accessed by the user device 310 without requiring a second device (a first device to display, and a second display to scan the display). Upon scanning of the QR code, the user device 310 can send a request 332 to the fund transfer server, requesting transaction information. The request can include one or more information (e.g., data, code, information uniquely encrypted in the QR code). Upon receipt of the request, the server can recall 334 the transaction information associated with the QR code, such as by searching the database of the server. The server can then send 336 the transaction information to the customer. The transaction information can be presented on an electronic display communicating with the user device 310. The transaction information can be presented on a GUI on the electronic display. In some instances, the transaction information can be presented in the form of an invoice (e.g., transaction information is located where it is conventionally located on an invoice, such as date on the top header, invoice sub-amounts at the bottom, invoice total below the invoice sub-amounts, and/other transaction details organized in table format, etc.). Upon presentation of the transaction information, the customer can verify 338 the transaction information for accuracy. If the customer determines that the transaction information is accurate, the customer can proceed with payment of the invoice such as by sending approval instructions to the server. If the customer determines that the transaction information is inaccurate, the customer can alert the server of such inaccuracy, such as by sending error alerts, disputes, or claims to the server. The server can communicate such error alerts, disputes, and/or claims from the customer to the merchant. As described with respect to FIG. 2, the transaction information can include request for an information transaction.

Alternatively, the customer (e.g., 302) can send a QR code request to the fund transfer server (e.g., 304). The QR code request can include information about the customer, such as the customer account information. In some instances, the QR code request can include information about the merchant (e.g., 306). In some instances, the QR code request can include information such as transaction details, a transaction identification number (ID) or any other information related to one or more transactions. For example, the QR code request can include at least all information that is printed on or included on the face of an invoice. Upon receipt of the QR code request from the customer, the fund transfer server can generate a QR code. The QR code can encode such customer account information provided by the customer. In some instances, the QR code can encode merchant information and/or transaction information provided by the customer (e.g., transaction details, transaction ID, and/or any information related to one or more transactions, etc.). The fund transfer server can otherwise associate such customer information, merchant information, and/or transaction information to the QR code. The server can store such association information in memory, such as in a database. The server can send the QR code to the customer. Alternatively or in addition, the fund transfer server can generate and send the customer a code (e.g., alphanumeric code) or other data that the customer can use to self-generate the QR code, and this code or other data can be associated with the transaction information in a database of the server.

Upon receipt of the QR code, the customer can present or otherwise display the QR code to the merchant. In some instances, the QR code can be printed on a paper and be physically delivered or tended to the merchant. In some instances, the QR code can be electronically delivered to the merchant, such as over a computer network. In some instances, the QR code can be electronically delivered to the merchant via the fund transfer server. In some instances, the QR code can be displayed to the merchant over a display. For example, the QR code can be displayed on a display provided by the customer (e.g., display of a user device) or a display of the merchant. The display may be, or be part of, a processing device (e.g., purchase processing device, cash register, etc.), a personal device (e.g., mobile phone, tablet, computer, monitor, etc.), or other device. Upon receipt of the QR code by the customer, the merchant can use an optical sensor of the merchant device (e.g., purchase processing device, cash register, scanner, personal device, etc,) to scan the QR code. In some instances, the merchant device may execute scanning or optical recognition algorithms to identify, recognize, and/or scan the QR code without requiring a second device (a first device to display, and a second display to scan the display). Upon scanning of the QR code, the merchant device can send a request to the fund transfer server, requesting transaction information. The request can include one or more information (e.g., data, code, information uniquely encrypted in the QR code). Upon receipt of the request, the server can recall the customer and/or transaction information associated with the QR code, such as by searching the database of the server. In some instances, upon scanning of the QR code or simultaneously with scanning of the QR code, the merchant may transmit supplement information about the transaction (e.g., transaction details, merchant information, etc.) to the server. The server can then send the transaction information to the customer. The transaction information can be presented on an electronic display communicating with the customer user device (e.g., 310). The transaction information can be presented on a GUI on the electronic display. In some instances, the transaction information can be presented in the form of an invoice (e.g., transaction information is located where it is conventionally located on an invoice, such as date on the top header, invoice sub-amounts at the bottom, invoice total below the invoice sub-amounts, and/other transaction details organized in table format, etc.). Upon presentation of the transaction information, the customer can verify the transaction information for accuracy. If the customer determines that the transaction information is accurate, the customer can proceed with payment of the invoice such as by sending approval instructions to the server. If the customer determines that the transaction information is inaccurate, the customer can alert the server of such inaccuracy, such as by sending error alerts, disputes, or claims to the server. The server can communicate such error alerts, disputes, and/or claims from the customer to the merchant.

The customer 302 can be required to complete an authentication process before sending approval instructions to the server 304. For example, upon sending an intention to approve (e.g., selecting an “approve” or “confirm” option (user interactive component such as a button)) to the server, the server can send an authentication request to the customer. Alternatively, the customer can authenticate and approve simultaneously. Optionally, the customer can approve without separate authentication.

The authentication request may allow the individual to authenticate the individual's identity via biometric authentication. In some instances, the user device 310 and/or server 304 can individually or collectively comprise a biometric module for authentication. A biometric module may comprise hardware and software components for collecting, storing, processing, translating or analyzing biometric data. Biometric data may include any feature or output of an organism that can be measured and used to uniquely identify the organism. Biometric data may include, but are not be limited to, fingerprints, DNA, body temperature, face/hand/retina or ear features, behavioral characteristics such as typing rhythm, gait, gestures and voice. Hardware components in a biometric module may further comprise biometric readers, for example a fingerprint reader or retinal scanner, microprocessors, and RAM/ROM memory. Software components may comprise one or more software-based programs, including applications, protocols, or plugins, configured for collecting and/or processing biometric data from the hardware components of the biometric module. In some instances, collection and processing biometric data may comprise steps for analyzing the biometric data, creating a template (i.e. digital template) for biometric data, storing, matching, and verifying the biometric data (i.e. with an external database or previously stored information). In some embodiments, a biometric reader may also be coupled to a user device through wired or wireless connections. Wireless connections may include one or more types of Wi-Fi or peer-to-peer (P2P) networking protocols. In other embodiments, a biometric reader may be built into the web-enabled device. In some embodiments, the biometric module may be included, installed, or attached to the user device 310.

Alternatively or in addition, the authentication request may allow authentication via user credentials (e.g., PIN, password, passcode, cryptographic proof, etc.). For example, prior to authentication, a user (e.., customer 302) may have provided the fund transfer server 304 with such user credentials, such as during or after registration with the server. Alternatively, or in addition, the authentication request may allow authentication via device (e.g., one-time password device, user device, etc.) authentication. Alternatively or in addition, the authentication request may allow authentication via third party service authentication (e.g., authentication via social networking system account, authentication via verified email account, etc.). If a recipient fails authentication, for example for a certain number of times (e.g., 3), the server may try contacting the customer 302 via a contact address (e.g., phone number, email address, etc.) to alert the customer 302 of possible fraud.

In some instances, the approval and/or authentication request may expire after a finite duration of time. An invoice may expire after a finite duration of time. For example, the request sent by the server 304 or invoice may expire after a certain period of time, such as in 10 seconds, 30 seconds, 1 minute, 5 minutes, 10 minutes, 30 minutes, 1 hour, 2 hours, 3 hours, 4 hours, 5 hours, 6 hours, 7 hours, 8 hours, 9 hours, 10 hours, 11 hours, 12 hours, 15 hours, 18 hours, 21 hours, 1 day (e.g., 24 hours), 2 days, 3 days, 4 days, 5 days, 6 days, 1 week (e.g., 7 days), 2 weeks, 3 weeks, 4 weeks, 1 month, 2 months, 3 months, 4 months, 5 months, 6 months, 9 months, 12 months, 1 year, 2 years, 3 years, or other duration of time. A QR code can have an expiration date. If a user does not provide approval and/or authentication within the certain period of time, the merchant 306 can be alerted, such as to encourage renewal of an invoice or remind payment of the invoice to the customer 302. In some instances, the QR code can include additional information, such as due date or due time of the payment, a number of times an invoice has been presented to the customer for payment, tax category of the payment, and/or other information. In some instances, upon expiration of an invoice, upon scanning of a QR code (e.g., after the due date or due time of the payment), the server can generate an error message informing the customer of the expiration. Alternatively, the request may not expire, and the customer may provide approval and/or authentication at any time.

With or after authentication, the customer 302 can send 340 approval instructions of the invoice to the fund transfer server 304. The approval instructions can instruct payment of the invoice to the merchant. In some instances, the approval instructions can include payment information required for payment of the invoice. In some instances, the payment information can be pre-stored in one or more secure (e.g., encrypted) databases of the server and the approval instructions can include approval from the customer for the server to use such payment instructions. Alternatively or in addition, the customer can manually input such payment information with or after authentication, and/or with approval. In some instances, the payment information can include the selection between digital tokens and fiat currency.

Upon receipt of the approval instructions, the server 304 can request 342 a transfer of funds from a customer 302 account to a merchant 306 account. For example, this can involve a transfer of funds from a financial institution account to a financial institution account and/or a transfer of digital tokens from a digital account to a digital account. Specifics of the payment can be provided by the customer (e.g., in the approval instructions, payment preferences for the customer, etc.) and/or the merchant (e.g., in the invoice, payment preferences for the merchant, etc.). The transfer of funds can be made on one or more blockchain networks. The transfer of funds can be requested to one or more financial institutions. In some instances, the transfer of funds can be achieved via systems and methods described elsewhere herein (e.g., breaking up the transfer process, clearing accounts, holding accounts, multiple clearing accounts, multiple holding accounts, timing, optimizing transfer time and cost, etc.). After receiving confirmation of fund transfer from one or more FIs, the server can mark the particular transaction ID as completed and/or the invoice as paid. Such completion information can be stored, referenced, or hashed on a blockchain or in one or more databases of the fund transfer server. The one or more databases of the server can be searchable. The one or more databases can individually or collectively perform or implement systems and methods described herein. Upon confirmation of fund transfer, the server 304 can then send 344A an invoice receipt to the customer 302 and send 344B a notice of the fund transfer to the merchant 306. In some instances, the invoice receipt and the notice of the fund transfer can be sent simultaneously. In some instances, the invoice receipt can be sent before confirmation of successful fund transfer, but after approval instructions are sent by the customer. In some instances, the invoice receipt can be sent after a request for a fund transfer is made to one or more FIs by the fund transfer server. For example, if a fund transfer fails after the request, the server can update the customer with such error and update the server databases to mark the transaction ID as incomplete.

At any point in time during the process, the merchant 306 can request from the server 304 a query about the status of invoices for the merchant. Upon receiving such query, the server 304 can scan the one or more databases for transaction IDs associated with the merchant to determine 348 the payment status of invoices for the merchant. For example, statuses of the invoices can include, but are not limited to, paid, unpaid, expired, overdue, cancelled, refunded, or other statuses. The server can send 350 such data, such as a list of unpaid invoices (e.g., transaction IDs) and/or a list of paid invoices, to the merchant. The user device 312 of the merchant 306 can be capable of presenting such data to the merchant, such as on a graphical user interface on an electronic display communicatively coupled to the user device 312. Alternatively or in addition, the customer 302 can request from the server a query on the status of invoices for the customer. Alternatively or in addition, the server may automatically provide, without manual request, a list of paid invoices and/or unpaid invoices, or invoices with other statuses, to a customer and/or merchant. For example, such lists can be provided periodically (e.g., annually, monthly, quarterly, biannually, bimonthly, weekly, biweekly, etc.), such as a part of a report. For each invoice, such list and/or report generated by the server can include information such as, payer (e.g., customer), payee (e.g., merchant), invoice number (e.g., transaction ID), amount paid, due date, payment date, method of payment, and/or other information related to a given invoice and/or payment of the given invoice. A report and/or list (e.g., requested or automatically generated) provided by the server can be filtered, sorted, and/or searched, such as by invoice status, by customer, by merchant, by due date, by invoice amount, and/or by any other data on or relating to the invoice.

Accounting data, such as reports and/or lists generated by the server 304, or any previous invoices using the fund transfer server can be imported by a user (e.g., customer, merchant), such as for incorporation into existing reports, statements, tax software, and/or accounting sheets.

While FIG. 3 shows one fund transfer server 304, there may be one or more fund transfer servers, collectively or individually, implementing the functions of the fund transfer server 304 described herein. For example, a first fund transfer server can generate the QR code, a second fund transfer server can facilitate transfer of funds, and a third fund transfer server can facilitate accounting by providing reports or list of paid and/or unpaid invoices.

In some instances, a customer and/or merchant may discover exceptions or errors in one or more invoices before or after payment by the customer. The customer and/or merchant can generate and/or report such exceptions to the server 304. The server can send the exception report to a payee FI, request reversal of payments made in error, inform the payee of the reversal, and/or thereafter send confirmation of corrected or updated electronic receipt for the refund.

Beneficially, translating such transaction and/or invoice information into electronic storage can provide long term storage. Further, allowing access of such information via scanning a QR code can facilitate convenient payment and/or accounting of invoices. For example, even if a paper invoice provides all information required or desired for payment (e.g., to a customer, from a merchant), such paper invoice can be lost easily, damaged (e.g., fading ink, torn, ripped, wrinkled, crumpled, folded, etc.), and accounting errors can be made while translating or transferring one or more information on the invoice (e.g., amount paid, amount to be paid) to an accounting sheet (e.g., hard copy or electronic) or accounting device (e.g., calculator).

In some embodiments, the invoice may be provided from the merchant to the customer without a QR code. The customer can scan the invoice without the QR code with an optical sensor (e.g., camera) on a user device. The optical sensor can, in conjunction with one or more OCR algorithms, read and recognize text and/or numbers from the invoice. Based on such reading and recognition, the server can identify the information needed for processing payment and automatically present such information to the customer, such as on a graphical user interface, for verification. Operations 338-344 can follow thereafter. In some instances, to aid accuracy of the one or more OCR algorithms, the server can provide an invoice template to the merchant. Alternatively or in addition, a merchant can provide an invoice template to the server. The one or more OCR algorithms can then be tailored to accurately recognize certain information from the invoice template (e.g., coordinate location of information relative to boundaries of an invoice). In some embodiments, QR codes can be pre-generated for goods or services (for sale).

Any and all communications between the customer 302, fund transfer server 304, and/or merchant 306 can be electronic (e.g., via electronic mail, via server user interface, etc.) or non-electronic (e.g., physically delivered, physically communicated). The customer and the merchant can be in the vicinity of each other (e.g., in same store, same restaurant, same gas station, etc.). The customer and merchant can be remote from each other. While FIG. 3 illustrates an invoice payment between a customer and a merchant, the payments are not limited as such. For example, the systems and methods described herein may be applicable to a point of sale system in a physical retail shop or an ecommerce online shopping system. For example, in some instances, the device 312 may be a point of sale system in a retail shop or a shopping card web page on an internet site.

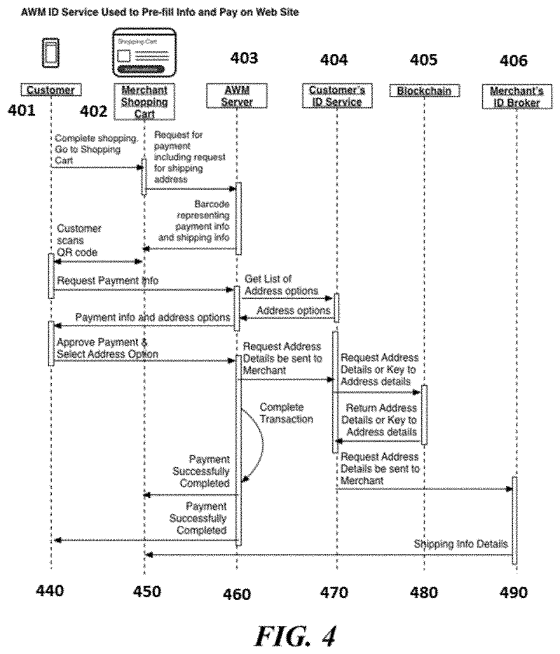

In some instances, the identity verification platform may facilitate form population on a web-based interface. FIG. 4 shows a process flow for facilitating form population on a web-based interface. In FIG. 4, the process(es) carried out by or involving a customer 401 (which may correspond to the first user with respect to FIG. 2) are represented by a contact with a vertical line 440, the process(es) carried out by or involving a merchant's (which may correspond to the second user with respect to FIG. 2) web-based interface 402 are represented by a contact with a vertical line 450, the process(es) carried out by or involving a fund transfer server 403 are represented by a contact with a vertical line 460, the process(es) carried out by or involving a first user's identity service 404 are represented by a contact with a vertical line 470, the process(es) carried out by or involving a blockchain 405 are represented by a contact with a vertical line 480, and the process(es) carried out by or involving the merchant's identity broker are represented by a contact with a vertical line 490.

A customer 401 can process a payment to a merchant by interfacing the web-based interface 402 provided by the merchant. The web-based interface may be administered and/or operated by a server of the merchant. For example, the customer may populate a virtual shopping cart with one or more goods or services and request purchase. The web-based interface may then transmit a request comprising (i) a request for payment from the customer, and (ii) a request for additional information, such as a request for shipping address, from the customer. In some instances, the request for additional information may be automatically requested based on the properties of one or more goods or services that the customer has selected (e.g., age-rated movie, alcohol, tobacco, etc.). In some instances, the request for additional information may automatically accompany any purchase request (e.g., additional information relating to shipping of purchased items). The request for additional information may be automatically requested based on other factors.

The request may be received by the fund transfer server 403. The fund transfer server may return a graphical code, such as a QR code, to the web-based interface 402. The graphical code may represent and be associated with payment transaction details and information transaction details based on the request for payment and request for additional information. The web-based interface may display the graphical code for scanning by the customer 401, such as with a user device of the customer. Upon scanning, the customer may request details of the payment transaction from the fund transfer server. The fund transfer server may also query the customer's identity service 404 for a list of address options available for selection by the customer. For example, the address options may be pre-defined information profiles by the customer, each information profile disclosing a different amount, level, and/or type of information relating to addresses. In some instances, the information profiles may be shared between a plurality of users, including the customer. For example, the fund transfer server may have pre-defined the shared information profiles. Once the identity service provides the list of address options, the fund transfer server may return payment transaction details and the address options to the customer.

Upon review of the transaction details and the address options, the customer 401 may approve payment, select one address option from the list of address options, and send such instructions to the fund transfer server 403. Based on the selected address option, the fund transfer server may transmit a request to the customer's identity service 404 for address details, as defined by the selected address option, to be sent to the merchant. The identity service may request and retrieve the key (to the address details) from the blockchain 405. Once the key has been received, the identity service may use the key to retrieve the address details, and transmit the address details to the merchant's identity broker 406. The identity broker may transmit the address details (e.g., shipping information details) to the web-based interface 402 of the merchant to complete the information transaction. Simultaneously or near simultaneously with requesting address details to be sent to the merchant, the fund transfer server may complete a fund transfer (e.g., see FIG. 3) per the payment transaction details. In some instances, success of completing payment transaction and/or success of completing information transaction may be notified to the customer 401 and/or the web-based interface.

In some instances, the information transaction may be independent of the financial transaction (e.g., even if such transactions are requested in the same request). For example, regardless of whether the customer allows or disallows the sharing of user data (e.g., identity verification data) with the recipient, the payment transaction may proceed if the customer approves the payment transaction details. For example, during a financial transaction, merchants may request additional data from customers, such as the customer's address and phone number, and it may be at the customer's sole discretion to make such information available to (or deny the information from) the merchant. In other instances, the success of an information transaction may be dependent on the parallel success of a financial transaction, or vice versa. Beneficially, the platforms described herein may allow a recipient to receive guaranteed funds in fiat currency and/or cryptocurrency without chargebacks or transaction fees.

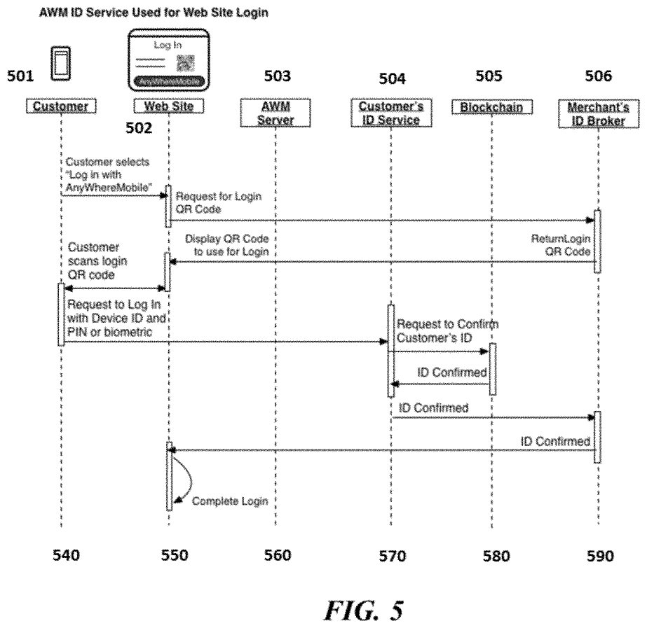

In some instances, the identity verification platform may facilitate validation of log-in credentials on a web-based interface. FIG. 5 shows a process flow for facilitating validation of log-in credentials on a web-based interface. In FIG. 5, the process(es) carried out by or involving a customer 501 (which may correspond to the first user with respect to FIG. 2) are represented by a contact with a vertical line 540, the process(es) carried out by or involving a merchant's (which may correspond to the second user with respect to FIG. 2) web-based interface 502 are represented by a contact with a vertical line 550, the process(es) carried out by or involving an identity verification server 503 are represented by a contact with a vertical line 560, the process(es) carried out by or involving a first user's identity service 504 are represented by a contact with a vertical line 570, the process(es) carried out by or involving a blockchain 505 are represented by a contact with a vertical line 580, and the process(es) carried out by or involving the merchant's identity broker are represented by a contact with a vertical line 590.

A customer 501 can login or otherwise gain access to a protected account of the customer on a web-based interface 502. The customer may have pre-existing user credentials (e.g., PIN, passcode, password, username, etc.) for protecting access to the web-based interface. The web-based interface may be administered and/or operated by a server of the merchant. For example, the customer may request to log-in to the web-based interface with aid of an identity verification server 503 by selecting an option to log-in with the identity verification server in the web-based interface (e.g., at a login page). The web-based interface may request for a login graphical code, such as a login QR code, from a merchant's identity broker. The graphical code may represent and be associated with the login request. The web-based interface may display the graphical code for scanning by the customer 501, such as with a user device of the customer.

Upon scanning, the customer 501 may request the customer's identity service 504 to login to the web-based interface 502 using alternative credentials (e.g., other than the credentials that the customer has registered with the web-based interface), such as using a device identifier (device ID), PIN, or biometric authentication. The customer's identity service may have associated such alternative credentials (and actual credentials for the web-based interface) with the customer, such as by storing the association data in the blockchain 505 in an encrypted or hashed form or as a reference to a separate server databases. Upon receipt of the request to login with alternative credentials, the identification service may request confirmation of the customer's identity (ID) from the blockchain 505. Upon confirmation of the customer's ID from the blockchain, the identity service may transmit confirmation of the customer's ID to the merchant's identity broker 506. Having confirmed that the customer's ID, the identity broker may relay such confirmation to the web-based interface 502 to complete the login.

Beneficially, the identity verification platform described herein may allow a user to use alternate credentials to prove the user's identity, and to use such alternate credentials to gain access to servers and/or web-based interfaces that are protected by different credentials. A user may associate any number of alternate credentials with the user's identity. In some instances, such alternate credentials may be associated with the user's unique user ID in the customer's identification service, stored in the blockchain. Another benefit is that it makes it possible for a user to log in to a web site on an untrusted network or device because no passwords are manually entered.

Provided herein are systems and methods for managing identity avatars, and their constructs.

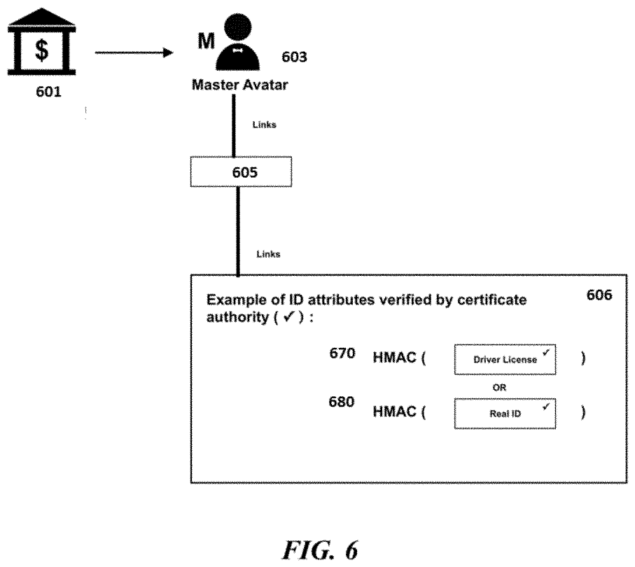

FIG. 6 illustrates an example method for creating a master identity profile or master avatar. A user may have a real identity that is verified by a verifying entity 601, such as a bank. The verifying information used to verify the real identity at the verifying entity 601 may be used to create a master avatar 603 (or master identity profile) of the user. The master avatar 603 may be assigned a unique master identifier (ID) 605 (or security number) which is unique to the user on a decentralized network (e.g., blockchain). The master ID 605 may be established on the blockchain. The master avatar 603 may comprise a set of ID data attributes (e.g., 670, 680) that are stored in a database 606 (which may comprise one more databases), and associated with the master ID 605. In some instances, the master ID 605 may be associated with identifications in multiple countries. The database 606 may be external to the blockchain. The ID data attributes may comprise data attributes that are verified by a certificate authority, such as the verifying entity 601 or other entities. The ID data attributes may comprise a plurality of data attributes verified by a plurality of different verifying entities. In some instances a single data attribute (e.g., Driver License, Real ID, etc.) may be verified by multiple different verifying entities. The data attributes stored in the database 606 may be hashed, such as by hash-based message authentication code (HMAC) algorithm(s), such that the actual user information (e.g., actual Driver License) is not stored on the database 606. The actual user information stored at the verifying entities may be provided to the database 606 only in hashed format, such as by HMAC algorithm(s). A private key of the user may be managed by the verifying entity 601. Alternatively or in addition, the private key may be managed by the user.

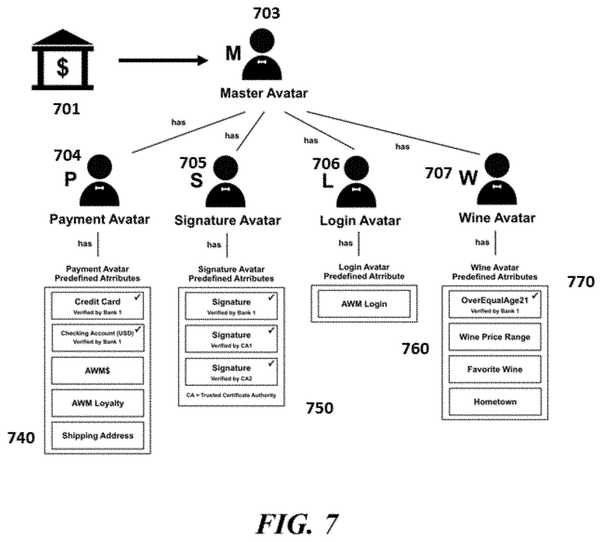

FIG. 7 illustrates an example method for creating multiple avatars associated with a master avatar. A user may have a real identity that is verified by a verifying entity 701, such as a bank, or other authoritative entity, as described elsewhere herein, which is used to create a master avatar 703, as described with respect to FIG. 6. The master avatar 703 may be assigned a unique master ID (or security number) which is established on the blockchain. The master avatar 703 may comprise a set of ID data attributes that are stored (e.g., in hashed form) in a database (which may comprise one more databases), associated with the master ID, and external to the blockchain. The ID data attributes may comprise data attributes that are verified by a certificate authority, such as the verifying entity 701 or other entities. The data attributes stored in the database may be hashed, as described elsewhere herein. A private key of the user may be managed by the verifying entity 701. Alternatively or in addition, the private key may be managed by the user (e.g., upon request). The master avatar 703 may be associated with a plurality of avatars (e.g., 704, 705, 706, 707), each representing different identity profiles of the same user, and associated with the Master ID. The plurality of avatars may each comprise, or be associated with, a different subset of predefined data attributes. For example, a first avatar 704 may be a payment avatar, comprising or associated with the following subset 740 of predefined data attributes: credit card, checking account, digital token, rewards, shipping address. For example, a second avatar 705 may be a signature avatar, comprising or associated with the following subset 750 of predefined data attributes: signature (verified by verifying entity 701), signature (verified by a second verifying entity), signature (verified by a third verifying entity). For example, a third avatar 706 may be a login avatar, comprising or associated with the following subset 760 of predefined data attributes: login. For example, a fourth avatar 707 may be a wine avatar, comprising or associated with the following subset 770 of predefined data attributes: OverEqualAge21, wine price range, favorite wine, hometown. Any custom avatar may be created, comprising or associated with any subset of predefined data attributes. Any number of data attributes (none, a subset, all) of any avatar may be verified by one or more verifying entities. An avatar may comprise data attributes verified by only one verifying entity, or verified by a plurality of verifying entities, or by no verifying entity.

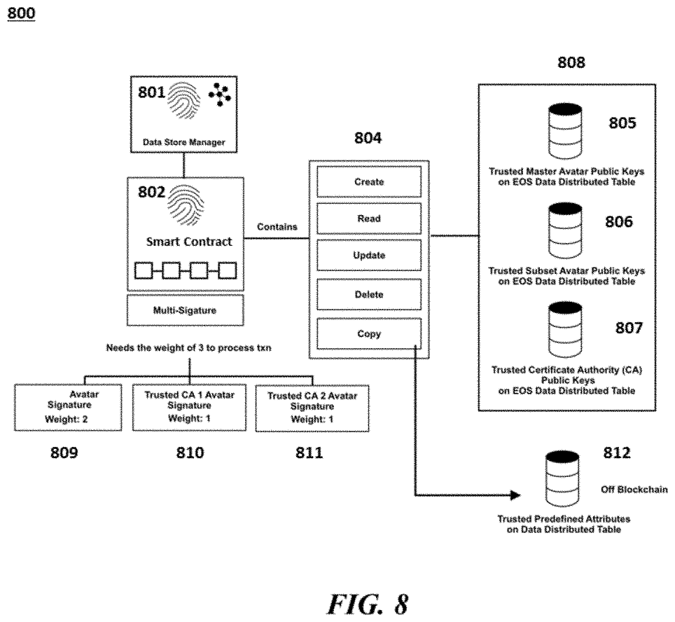

FIG. 8 illustrates an example process flow of an identity verification platform. An identity verification platform 800 may comprise one or more trusted data stores which are verified by a trusted verifying entity, such as a trusted certificate authority. The trusted data store may comprise a list of verified signatures of the verifying authority. A trusted verifying entity may in turn be verified by an operator or a server of the identity verification platform. A verified signature of a certificate authority may be used to verify one or more predefined attributes in an avatar. A trusted public key data store 808 may comprise a data unit 805 (e.g., data distributed table, database, etc.) comprising trusted master avatar public keys, a data unit 806 comprising trusted subset avatar public keys, and/or a data unit 807 comprising trusted verifying entity (e.g., certificate authority) public keys.

A blockchain 804 may comprise one or more smart contracts 802 that manage one or more transactions on the blockchain (or to be recorded on the blockchain), and/or access rights of one or more databases that are on or off the blockchain. In some instances, a transaction may comprise a broadcast and/or airdrop of information and/or digital tokens. In some instances, a transaction may comprise a fund transfer. In some instances, a transaction may require a certain (or predetermined) number, identity, and/or weight of signature(s) to process. In some instances, such requirement may correlate to a level of identity verification desired for the transaction, where signatures associated with a certain combination of data attributes that can be used for identity verification can satisfy the requirement. In some instances, an avatar may comprise a subset of data attributes that satisfies this requirement. In some instances, an avatar may comprise a subset of data attributes that does not satisfy this requirement, in which case such avatar may not be used in conjunction with this transaction. In an example, a transaction may require a signature from certain authorities and/or avatars to process. In another example, a transaction may require a predetermined weight of signatures to process. In some instances, signatures from different sources may be assigned a weight, and there may be a predetermined weight threshold for the transaction to process. In an example, an avatar signature is assigned a weight of 2, a first certificate authority signature is assigned a weight of 1, and a second certificate authority signature is assigned a weight of 1, and the predetermined weight threshold is 3. In this example, a combination of the avatar signature and the first certificate authority signature , a combination of the avatar signature and the second certificate authority signature, and a combination of the avatar signature, the first certificate authority signature, and the second certificate authority signature, may each satisfy the predetermined weight threshold, but other combinations of the three signatures (e.g., fist certificate authority signature and second certificate authority signature only) may not satisfy the predetermined weight threshold to process the transaction. Beneficially, such weighted multi-signature scheme may allow a transaction to be associated with a flexible level of identity verification level. In the above example, for instance, the transaction will not process without an avatar signature, as it is required to meet the predetermined weight threshold of 3.

In some instances, only transactions satisfying the smart contract 802 may be recorded on the blockchain 804. Predefined data attributes may not be recorded on the blockchain 804. For example, predefined data attributes (e.g., verified avatar's information) may be stored in a data unit 812 comprising trusted predefined attributes, off the blockchain 804. Independent of the blockchain 804 and the smart contract 802, a master avatar may, with freedom, set its own predefined attributes on the data unit 812.

The trusted public key data store 808 may store data both on and off the blockchain 804, where a record of transactions, including sensitive and/or detailed information, can be stored off the blockchain 804, and a record of transactions, without such sensitive and/or detailed information, can be stored on the blockchain 804. The two stored copies may be synchronized. In some instances, the copy stored on the blockchain 804 may comprise a transaction identifier, such as a receipt number, that may link to the off-blockchain copy of the transaction. In some instances, the copy stored off the blockchain 804 may comprise a transaction identifier that may link to the on-blockchain copy of the transaction. The trusted public key data store 808 may be accessed through a data store manager 801 or other authorized user whose ID has been verified. The data store manager 801 or other authorized user may have Create, Read, Update, Delete (CRUD), and/or Copy accesses to the data store 808. The data store manager 801 or other authorized user may have Read and Copy accesses to the data unit 812 comprising the predefined attributes. In some instances, such access may be a function of a smart contract.

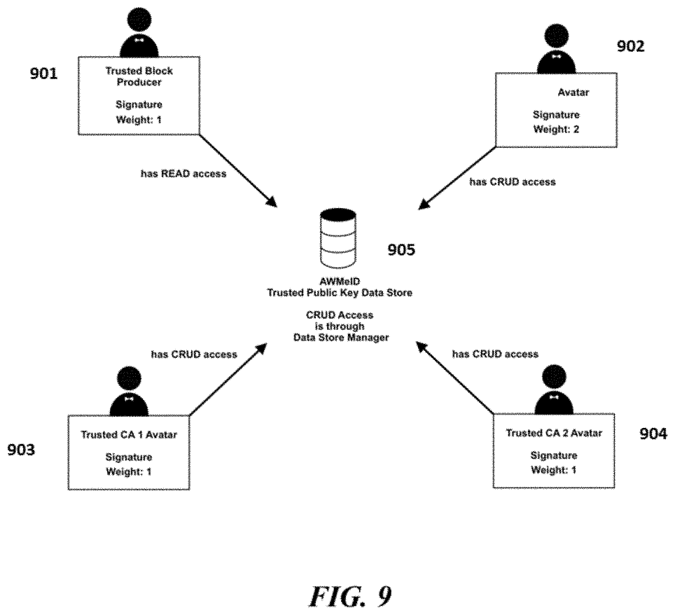

FIG. 9 illustrates examples of access privileges for a trusted public key data store. A trusted public key data store 905 may be accessed with different user privileges. For example, a trusted block producer avatar 901 may have read only access, a trusted avatar 902 may have CRUD access, a first verifying entity (e.g., certificate authority) avatar 903 may have CRUD access, and a second verifying entity (e.g., certificate authority) avatar 904 may have CRUD access. In some instances, CRUD access may be through the data store manager (e.g., 801). In some instances, each of the different avatars may be assigned a distinct signature weight value, such as to determine whether a transaction may process, as described with respect to FIG. 8.

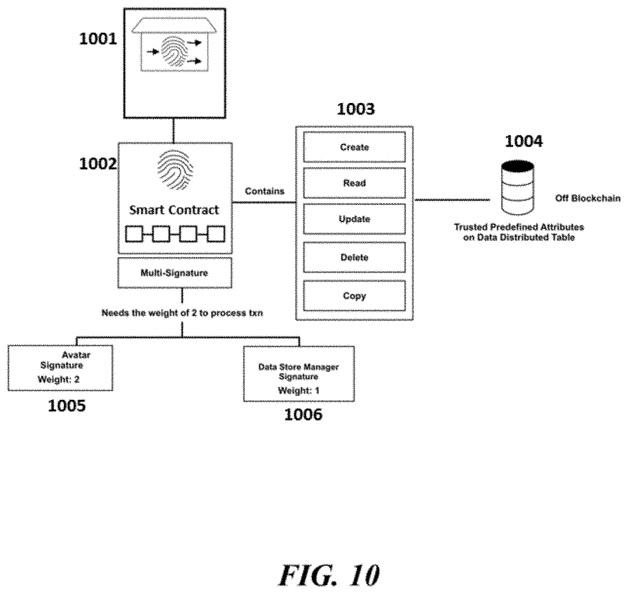

FIG. 10 illustrates another example process flow of an identity verification platform. A broadcast (e.g., of digital tokens) transaction 1001 may require identity verification of one or more avatars, for example, in order to broadcast a digital token to the one or more avatars based on one or more conditions (e.g., age, location, income, etc.). A smart contract 1002 on a blockchain 1003 may require satisfaction of a predetermined signature weight threshold (e.g., 2) to provide access privileges (e.g., CRUD access) to the predefined attributes data unit 1004 off the blockchain 1003. A trusted avatar signature may be assigned a weight of 2 and a data store manager signature may be assigned a weight of 1. If the threshold is satisfied (e.g., by providing at least the trusted avatar signature), access to the data unit 1004 may be granted. In some instances, one time access token may be provided.

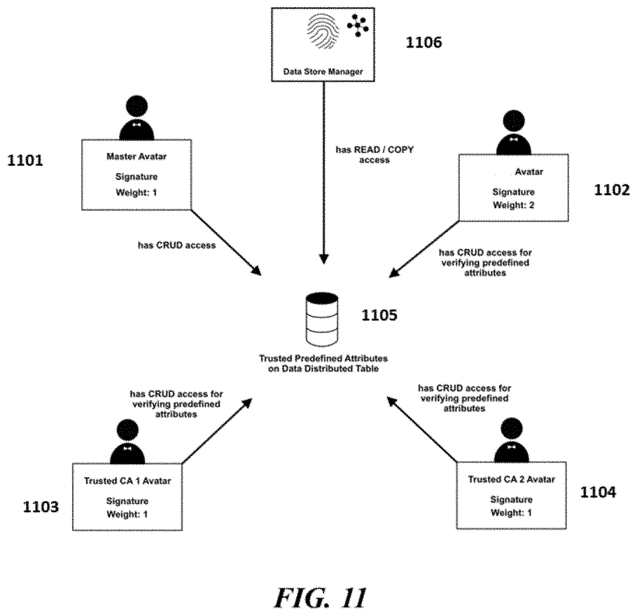

FIG. 11 illustrates examples of access privileges for a trusted predefined attributes data unit. A trusted predefined attributes data unit 1105 may be accessed with different user privileges. For example, a master avatar 1101 may have CRUD access, as described elsewhere herein. A trusted avatar may 1102, a first verifying entity (e.g., certificate authority) avatar 1103, and a second verifying entity (e.g., certificate authority) avatar 1104 may each have CRUD access for verifying predefined attributes. In some instances, each of the different avatars may be assigned a distinct signature weight value, such as to determine whether a transaction may process, as described with respect to FIG. 8.

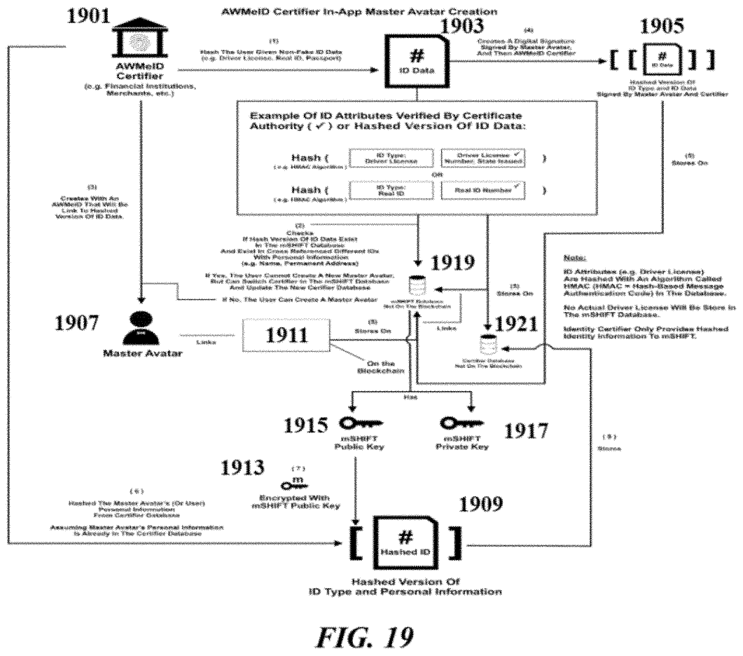

FIG. 19 illustrates an example process flow for creating a master identity profile or master avatar. A user may have a real identity (ID) that is verified by a verifying entity 1901, such as a bank or other authoritative entity, as described elsewhere herein. The verifying entity 1901 may hash the user's ID data to generate hashed ID data 1903, and store the hashed ID data on each of (i) an external database 1919 that is not on a blockchain which contains the master identifier 1911 and (ii) a verifying entity database 1921 that is also external to the blockchain. The external database 1919, while described in singular form, may comprise one or more databases. The verifying entity database 1921, while described in singular form, may comprise one or more databases. The hashed ID data may comprise one or more data attributes. In some instances, a data attribute may comprise an ‘ID type’ (e.g., driver's license) and corresponding ‘ID type value’ (e.g., driver license number). The data attributes stored in the databases 1919, 1921 may be hashed, such as by hash-based message authentication code (HMAC) algorithm(s), such that the actual user information (e.g., actual driver license) is not stored on the databases 1919, 1921. The actual user information may be provided to the databases 1919, 1921 only in hashed format by the verifying entity. A private key of the master avatar may be managed by the verifying entity 1901. Alternatively or in addition, the private key may be managed by the user (e.g., upon request).

In some embodiments, prior to storing the hashed ID data on the external database 1919, the verifying entity 1901 may perform a cross-reference search with data attributes of the ID data (e.g., name, permanent address, etc.) against existing data attributes in the external database 1919 to confirm that the user is unique to the system. For example, the verifying entity 1901 may (i) determine that the user is not unique to the system if there is overlapping data (e.g., to a certain degree, any overlapping data, etc.) already stored in the external database 1919, or (ii) determine that the user is unique to the system if there is no overlapping data (e.g., to a certain degree, no overlapping data at all, etc.) already stored in the external database 1919. Upon confirmation that the user is unique to the system, the hashed ID data 1903 may be stored in the external database 1919, and master avatar created. Upon confirmation that the user is not unique to the system, the hashed ID data 1903 may not be stored in the database 1919, and the user may be denied creation of a new master avatar. In such cases, the user may switch verifying entities, e.g., to the verifying entity that certified the existing master avatar for the user.

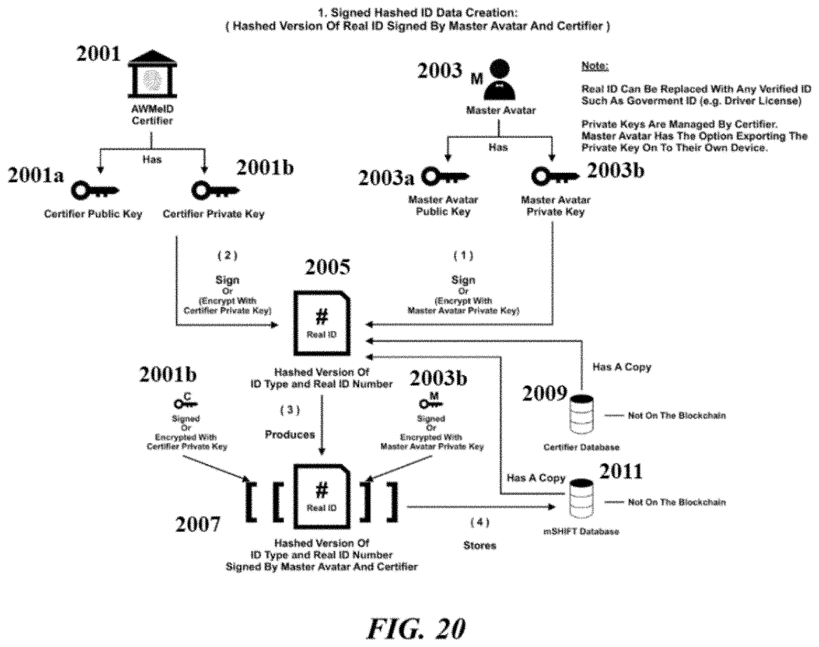

The verifying entity 1901 may create a master avatar 1907 (or master identity profile) of the user. The master avatar 1907 may be assigned a unique master identifier (ID) 1911 (or security number) which is unique to the user on a decentralized network (e.g., the blockchain). The master ID 1911 may be established on the blockchain. The master ID 1911 may be stored in the external database 1919. The master avatar 1907 and/or the master ID 1911 may comprise or be associated with the hashed ID data 1903 that are stored in the external database 1919. A digital signature may be created. The master avatar 1907 and the verifying entity 1901 may each sign the hashed ID data 1903 with the respective private key to generate signed, hashed ID data 1905. Further details on the creation of signed, hashed ID data, is provided elsewhere herein, such as with respect to FIG. 20. The signed, hashed ID data 1905 may be stored in the external database 1919, and linked to the hashed ID data 1903. The external database 1919 may comprise a public key and private key. Personal information of the master avatar 1907 or the user may be hashed by the verifying entity 1901, encrypted with the public key of the external database 1919, and stored on the verifying entity database 1921.

FIG. 20 illustrates an example process flow for creating signed, hashed ID data. A verifying entity 2001 may comprise a certifier public key 2001a and certifier private key 2001b. A master avatar 2003 may comprise a master avatar public key 2003a and master avatar private key 2003b. The master avatar private key 2003b may be managed by the verifying entity 2001, and/or by the master avatar 2003 or user thereof upon request (e.g., by exporting onto the user device). Hashed ID data 2005, which copy can exist on (i) a verifying entity database 2009 that is external to the blockchain comprising the master avatar ID and (ii) an external database 2011 also not on a blockchain, may be signed by the master avatar private key 2003b and the certifier private key 2001b to generate the signed, hashed ID data 2007. The signed, hashed ID data 2007 may be stored in the external database 2011. The external database 2011, while described in singular form may comprise one or more databases. The verifying entity database 2009, while described in singular form may comprise one or more databases.

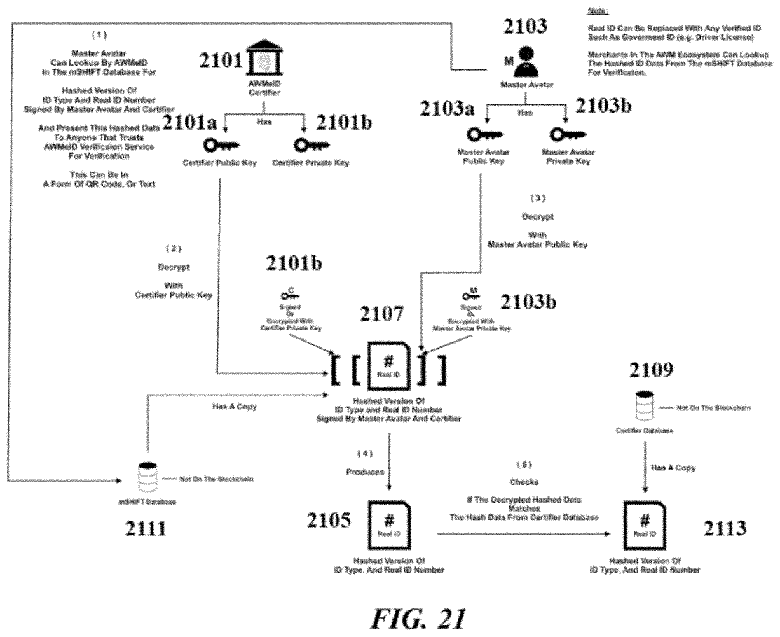

FIG. 21 illustrates an example process flow for verifying signed, hashed ID data. A verifying entity 2101 may comprise a certifier public key 2101a and certifier private key 2101b. A master avatar 2103 associated with a user may comprise a master avatar public key 2103a and master avatar private key 2103b. Signed, hashed ID data 2107 may have been signed by each of the certifier private key 2101b and the master avatar private key 2103b. The master avatar 2103 may search an external database 2111 (not on the blockchain), using the master avatar ID, for the signed, hashed ID data. Hashed data may be presented to anyone requiring and/or requesting ID verification from the user. Such requesters may trust the ID verification systems (e.g., the verifying entities) described herein. For example, such request for ID verification and/or presentation of hashed ID data may be facilitated by use of a graphical code, such as a quick response code (QR) code, and/or text. The signed, hashed ID data 2107 may be decrypted with the certifier public key 2101a and the master avatar private key 2103a, respectively, to generate the hashed ID data 2105. The hashed ID data 2105, which copy 2113 exists on a verifying entity database 2109 that is external to the blockchain comprising the master avatar ID, may be matched against the copy 2113 to verify the data. The external database 2111, while described in singular form may comprise one or more databases. The verifying entity database 2109, while described in singular form may comprise one or more databases.

Provided are example data structures for storing master avatar data. Master avatar data may be stored in a table, for example, containing one or more of the following columns: unique verified ID (e.g., HMAC(Driver License)), master avatar public address (e.g., master avatar ID), certificate authority verified (e.g., Bank1PrivateKey(HMAC(Driver License))), unique trusted certificate authority index ID (e.g., index ID), master avatar trusted public key (e.g., public key), subset avatar (e.g., subset avatar ID), and/or other columns. Importantly, the unique verified ID column, which may comprise the sensitive information of a user associated with the master avatar, may be stored off the blockchain.

Provided are example data structures for storing subset avatar data. A subset avatar may be any avatar associated with a master avatar that is not the master avatar. Subset avatar data may be stored in a table, for example, containing one or more of the following columns: master avatar public address (e.g., master avatar ID), subset avatar public address (e.g., subset avatar ID), and subset avatar public trusted public key (e.g., public key), and/or other columns. Beneficially, a subset avatar ID may be identified from such table based on the master avatar ID.

Provided are example data structures for storing trusted certificate authority (CA) data. Trusted CA data may be stored in a table, for example, containing one or more of the following columns: unique trusted certificate authority index ID (e.g., index ID), certificate authority trusted public key (e.g., public key), and core data address link (e.g., core data URI), and/or other columns. The Trusted CA data may be stored on the blockchain, for example, using a distributed table. Such distributed table may be accessed via CRUD operations from a Trusted CA smart contract. In some instances, the CRUD operations can comprise access only rights by a trusted entity (e.g., block producer, certificate authority, etc.). The term “trusted entity,” as used herein, is interchangeable with “verifying entity.”

Provided are example data structures for storing trusted predefined attributes data. Trusted predefined attributes data may be stored in a table, for example, containing one or more of the following columns: master avatar public address (e.g., master avatar ID), subset avatar public address (e.g., subset avatar ID), unique trusted certificate authority index ID (e.g., index ID), over 21 (e.g., yes, no), food likes (e.g., hamburger, pizza, tacos, etc.), food dislikes (e.g., salads), sex (e.g., F, M), other predefined data attribute types, and/or other columns. Beneficially, a predefined attribute may be identified from such table based on the master avatar ID and/or subset avatar ID.

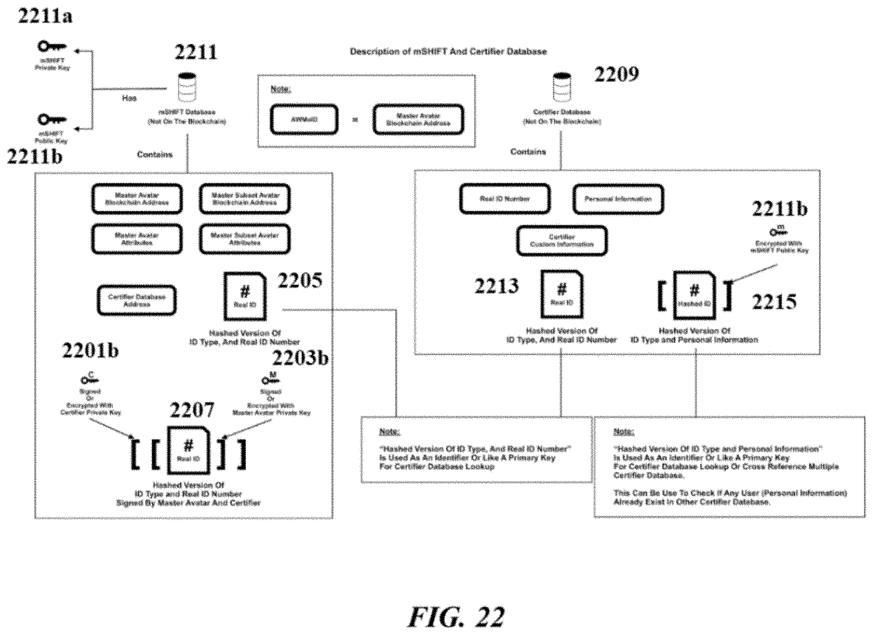

FIG. 22 illustrates an external database and a verifying entity database in accordance with embodiments of the present disclosure. An external database 2211 (e.g., 1919 of FIG. 19, 2011 of FIG. 20, 2111 of FIG. 21), while described in singular form may comprise one or more databases. A verifying entity database 2209 (e.g., 1921 of FIG. 19, 2009 of FIG. 20, 2109 of FIG. 21), while described in singular form may comprise one or more databases. The external database 2211 may comprise a private key 2211a and a public key 2211b. The external database 2211 may comprise data, such as: master avatar ID (or master avatar blockchain address), master avatar attributes, subset avatar ID (or master subset avatar blockchain address), subset avatar attributes, the verifying entity database 2209 address, hashed ID data 2205, and signed, hashed data 2207 which has been signed by a verifying entity private key 2201b and a master avatar private key 2203b. The verifying entity database 2209 may comprise real ID data (e.g., personal information, real ID number, etc.), verifying entity custom information, hashed ID data 2213, and encrypted, hashed ID data 2215 which has been encrypted by the public key 2211b of the external database 2211. The hashed ID data 2205 and the hashed ID data 2213 may be used as an identifier, such as a primary key, to search the database. The encrypted, hashed ID data 2215 may be used as an identifier, such as a primary key, to search the verifying entity database 2209 and/or for cross-reference purposes (e.g., to identify if a user already has a master avatar ID), as described elsewhere herein.

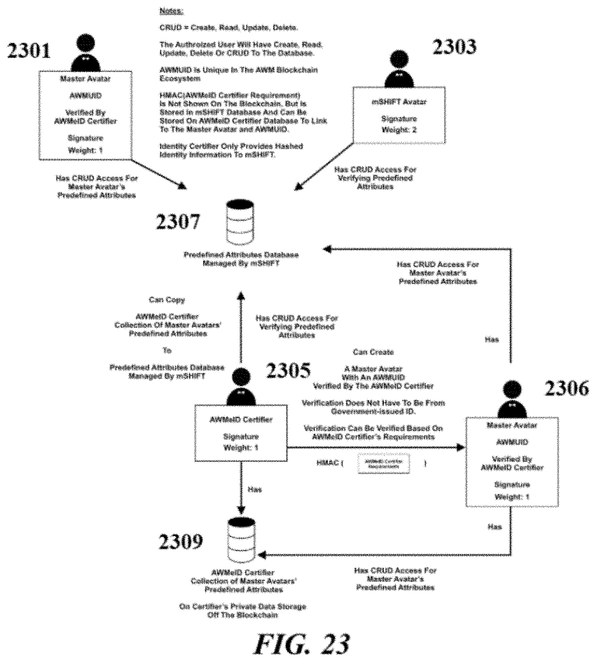

FIG. 23 illustrates examples of access privileges for a trusted predefined attributes data unit. A trusted predefined attributes data unit 2307, while illustrated as a singular data unit, may comprise one or more databases. The trusted predefined attributes data unit 2307 may be accessed with different user privileges. For example, a master avatar 2301 associated with a first user may have CRUD access for the master avatar's predefined attributes, as described elsewhere herein. The master avatar 2301 may be associated with a unique avatar identifier or, interchangeably, any unique identifier (or blockchain address) that is unique in the blockchain network. A trusted avatar 2303 and a verifying entity (e.g., certificate authority) avatar 2305 may each have CRUD access for verifying the master avatar's predefined attributes. In some instances, each of the different avatars may be assigned a distinct signature weight value, such as to determine whether a transaction may process, as described with respect to FIG. 8. The verifying entity avatar 2305 may have permission to create a master avatar 2306 (e.g., for a second user), wherein verification of the identity of the second user can be verified based on the verifying entity's requirements. The verifying entity may have permission and/or ownership of a verifying entity database (off the blockchain described herein) 2309, which may comprise master avatars' predefined attributes data for those master avatars certified by the verifying entity, and such master avatars (e.g., 2306) certified by the verifying entity may have CRUD access to the verifying entity database 2309 for the master avatar's 2306 predetermined attributes. The master avatar 2306 may have CRUD access for the master avatar's 2306 predetermined attributes.

Provided herein are systems and methods for searching for transaction histories of a user.

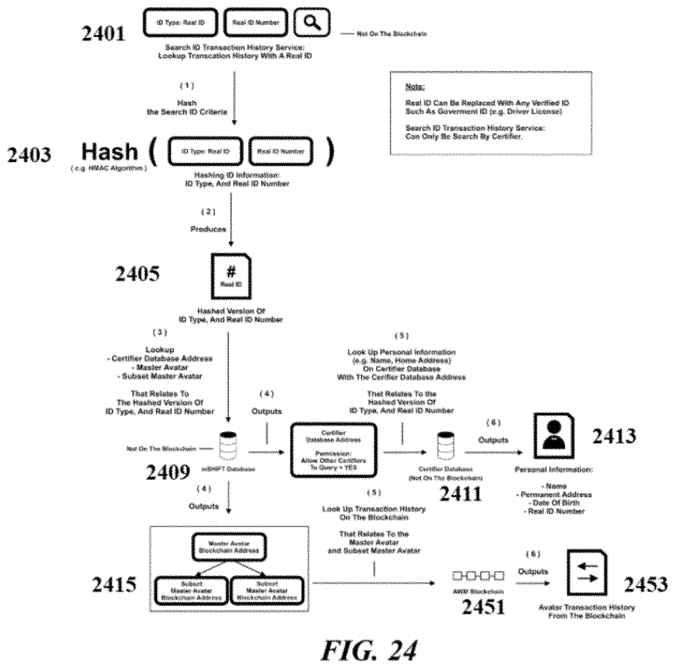

FIG. 24 illustrates example process flows for searching transaction histories of a user based on a real identity. An ID search tool may allow a searching user to provide input identity data of a user to search for transaction histories of the user on a blockchain. The searching user (e.g., individual, entity, etc.) may provide input identity data 2401 in response to a search criteria on an interface (e.g., web-based interface, mobile-based interface, etc.). The input identity data may comprise an ‘ID type’ (e.g., driver license) and ‘ID type value’) (e.g., driver license number). The input identity data may be hashed 2403 (e.g., via HMAC algorithm(s)) to generate a hashed ID data 2405. The hashed ID data 2405 may be used to search an external database 2409 (not on the blockchain 2451; e.g., 2211) for data that relates to the hashed ID data 2405. For example, the hashed ID data 2405 may be used to search master avatar data, subset avatar data, and verifying entity database address data in the external database 2409. This search may output (1) one or more verifying entity database addresses (wherein permission to allow other certifiers to query =YES), and/or (2) master avatar addresses (and optionally associated subset avatar addresses for the master avatar) 2415. The (1) one or more verifying entity database addresses may be used to direct a search of the respective one or more verifying entity databases (not on blockchain 2451; e.g., 2209), such as verifying entity database 2411, for data that relates to the hashed ID data 2405. This search may output personal information 2413 of the user (e.g., name, permanent address, date of birth, ID number, etc.). The (2) master avatar addresses (and optionally associated subset avatar addresses) may be used to direct a search of transaction histories on a blockchain 2451 to output the avatar transaction histories 2453 for the master avatar (and optionally associated subset avatar addresses). One or more outputs may be returned to the searching user via the interface.

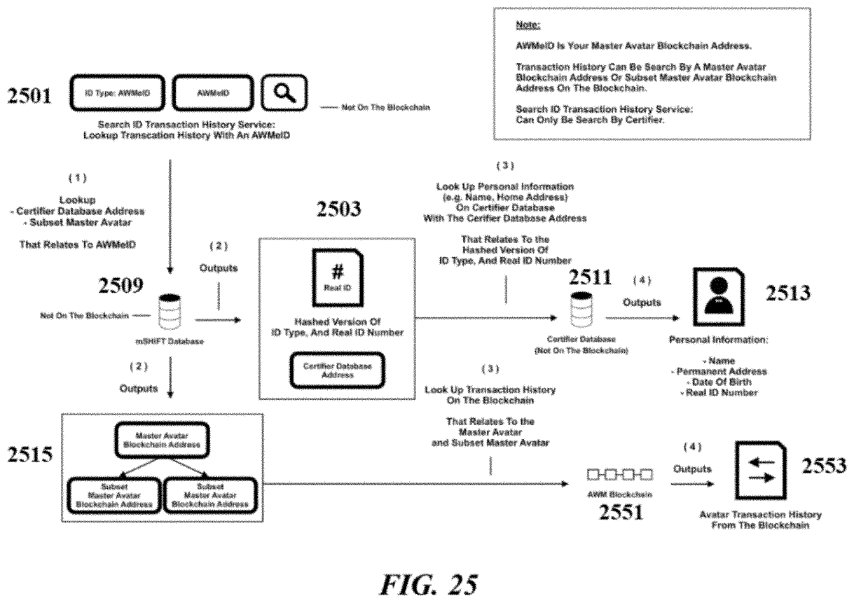

FIG. 25 illustrates example process flows for searching transaction histories of a user based on an avatar identifier. An ID search tool may allow a searching user to provide an avatar identifier of a user to search for transaction histories of the user on a blockchain. The searching user (e.g., individual, entity, etc.) may provide input identity data 2501 in response to a search criteria on an interface (e.g., web-based interface, mobile-based interface, etc.). The input identity data may comprise an ‘ID type’ (e.g., avatar identifier) and ‘ID type value’) (e.g., avatar identifier value). The avatar identifier may be used to search an external database 2509 (not on the blockchain 2551; e.g., 2211) for data that relates to the avatar identifier. For example, the avatar identifier may be used to search master avatar data, subset avatar data, and verifying entity database address data in the external database 2509. This search may output (1) hashed ID data 2503 and associated one or more verifying entity database addresses, and/or (2) master avatar addresses (and optionally associated subset avatar addresses for the master avatar) 2515. The (1) one or more verifying entity database addresses may be used to direct a search of the respective one or more verifying entity databases (not on blockchain 2551; e.g., 2209), such as verifying entity database 2511, for data that relates to the hashed ID data 2503. This search may output personal information 2513 of the user (e.g., name, permanent address, date of birth, ID number, etc.). The (2) master avatar addresses (and optionally associated subset avatar addresses) may be used to direct a search of transaction histories on a blockchain 2551 to output the avatar transaction histories 2553 for the master avatar (and optionally associated subset avatar addresses). One or more outputs may be returned to the searching user via the interface.

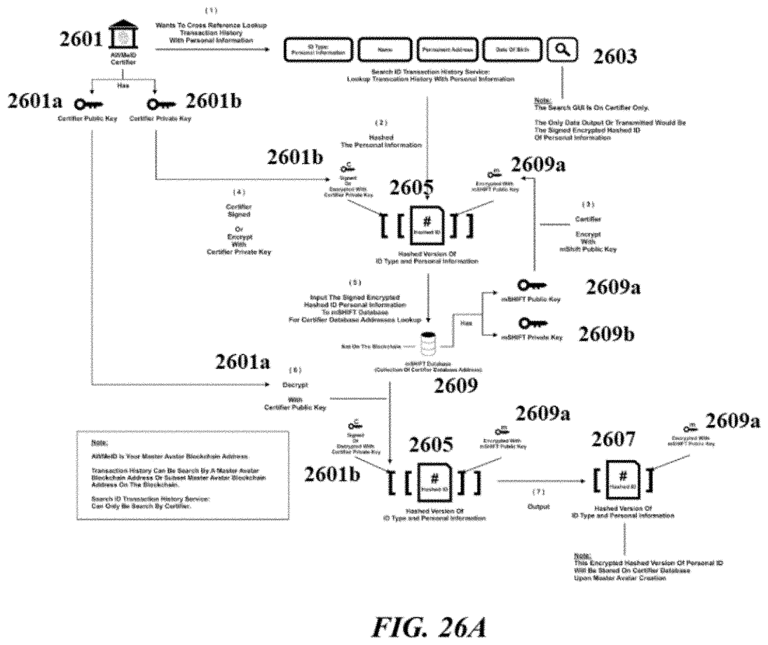

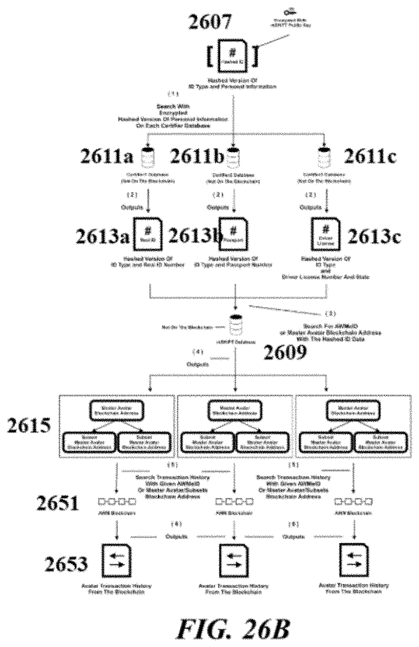

FIGS. 26A-26B illustrate example process flows for searching transaction histories of a user based on personal information. Referring to FIG. 26A, an ID search tool may allow a verifying entity 2601 to provide input identity data (e.g., personal information) of a user to cross-reference and search for transaction histories of the user, such as to verify whether the user already has a master avatar on the blockchain. The verifying entity 2601 may comprise a verifying entity public key 2601a and a verifying entity private key 2601b. The verifying entity 2601 may provide input identity data 2603 in response to a search criteria on an interface (e.g., web-based interface, mobile-based interface, etc.). The input identity data 2603 may comprise an ‘ID type’ (e.g., personal information) and ‘ID type value’ (e.g., name, permanent address, date of birth, etc.). The input identity data 2603 may be hashed (e.g., via HMAC algorithm(s)) and signed by each of the verifying entity private key 2601b and a public key 2609a of an external database 2609 (not on blockchain; e.g., 2211) to generate signed, hashed ID data 2605. The signed, hashed ID data 2605 may be used to search the external database 2609. The external database 2609 may comprise the public key 2609a and a private key 2609b. After the signed, hashed ID data 2605 is input into the external database 2609, the verifying entity public key 2601a may be used to decrypt the signed, hashed ID data 2605 to output a encrypted, hashed ID data 2607 that is still encrypted with the public key 2609a. Such encrypted, hashed ID data 2607 may be stored on verifying entity database(s) (see 2611a-c in FIG. 26B; e.g., 2209) upon master avatar creation for the user. Referring to FIG. 26B, the encrypted, hashed ID data 2607 may be used to search one or more verifying entity databases (e.g., 2611a-c). For example, each type of personal information (e.g., real ID; passport number; driver license number) may be verified and contained in a different verifying entity database. This search may output hashed versions of the personal information data 2613a-c, from the respective verifying entity database(s). The hashed versions of the personal information data 2613a-c may be used to search the external database 2609 for master avatar data and subset avatar data. This search may output master avatar addresses (and optionally associated subset avatar addresses) 2615, which may be used to direct a search of transaction histories on a blockchain 2651 to output the avatar transaction histories 2653 for the master avatar (and optionally associated subset avatar addresses). One or more outputs may be returned to the searching user via the interface.

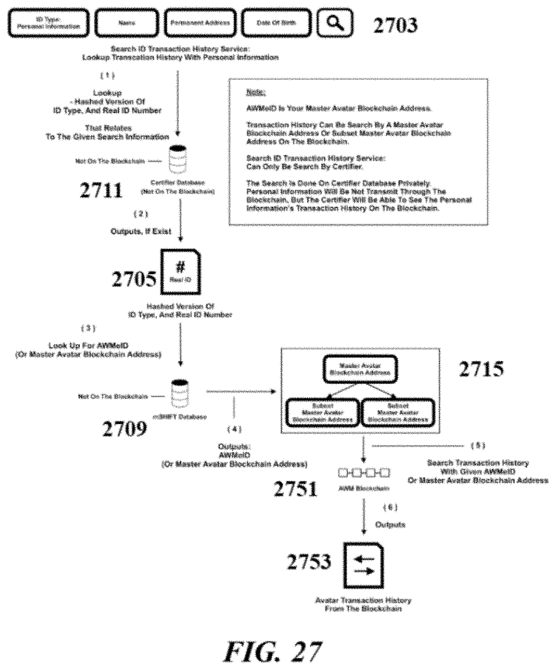

FIG. 27 illustrates other example process flows for searching transaction histories of a user based on personal information. A verifying entity's own database may be privately searched based on personal information, wherein the personal information is not transmitted across the Internet (or through the blockchain). An ID search tool may allow a searching user (e.g., identity, entity, etc.) to provide input identity data (e.g., personal information) of a user to search for transaction histories of the user. The searching user may provide input identity data 2703 in response to a search criteria on an interface (e.g., web-based interface, mobile-based interface, etc.). The input identity data 2703 may comprise an ‘ID type’ (e.g., personal information) and ‘ID type value’ (e.g., name, permanent address, date of birth, etc.). The input identity data 2703 may be input into a verifying entity database 2711 (not on blockchain 2751; e.g., 2209) to output hashed ID data 2705 that is related to the input identity data 2703. The hashed ID data 2705 may be used to search an external database 2709 (not on blockchain 2751; e.g., 2211) for master avatar data and subset avatar data. This search may output master avatar addresses (and optionally associated subset avatar addresses) 2715, which may be used to direct a search of transaction histories on the blockchain 2751 to output the avatar transaction histories 2753 for the master avatar (and optionally associated subset avatar addresses) identified to be associated with the user. One or more outputs may be returned to the searching user via the interface.

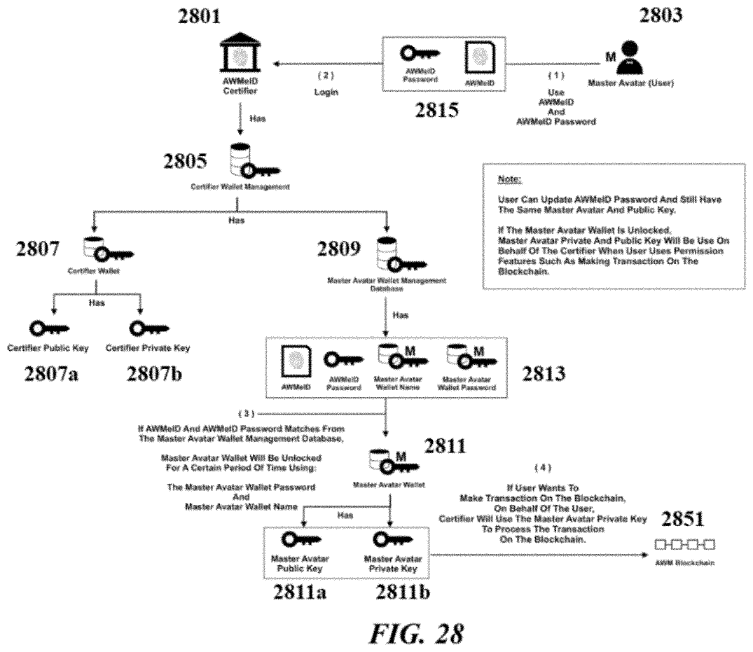

FIG. 28 illustrates a verifying entity key management system. A user, associated with master avatar 2803, may be registered with a verifying entity 2801. The user may access a master avatar key management system by logging in to the system with one or more user validation methods 2815 (e.g., by inputting a user ID (e.g., avatar ID) and corresponding password). The verifying entity 2801 may comprise (or have access to) a certifier wallet management database 2805. The certifier wallet management database 2805 may comprise a certifier wallet 2807 and a master avatar wallet management database 2809. The certifier wallet 2807 may comprise a verifying entity public key 2807a and verifying entity private key 2807b. The master avatar management database 2809 may comprise master avatar IDs, passwords, master avatar wallet names, and master avatar wallet passwords 2813. If the user ID and corresponding password input during log-in (e.g., 2815) matches the master avatar Ids and passwords stored on the master avatar management database 2809, the user may further unlock a master avatar wallet 2811 using a master avatar wallet name and corresponding master avatar wallet password. The master avatar wallet 2811 may comprise a master avatar public key 2811a and master avatar private key 2811b. When a user requests a transaction on blockchain 2851, the user may, or the verifying entity 2801 on behalf of the user may, use the master avatar private key 2811b to process the transaction on the blockchain 2851.

The identity verification platforms provided herein can be used for various applications, including for example, applications in or related to banks, credit unions, insurance companies, law firms, accounting firms, e-commerce retailers, government services, utility companies, telecom companies, education institutions, hospitals, notary, escrow, and the like.

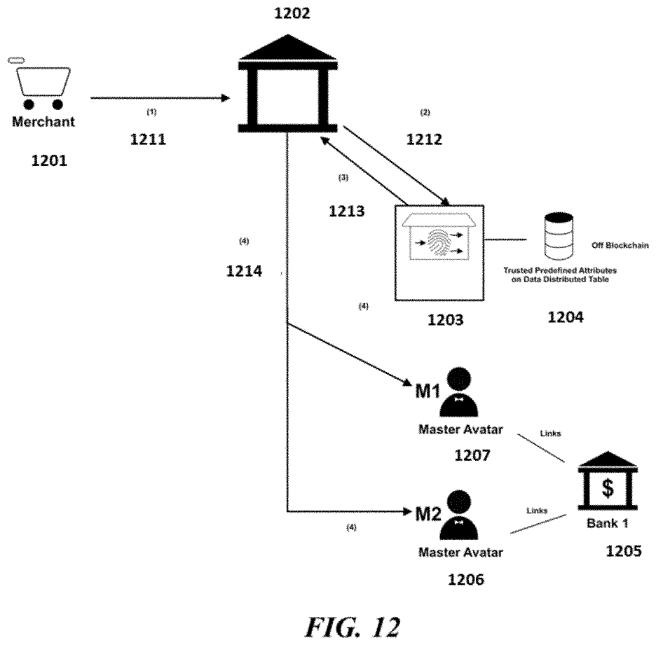

FIG. 12 illustrates an example of an airdrop process flow using an identity verification platform. At a first operation 1211, a merchant 1201 can indicate an airdrop broadcast criteria. The airdrop broadcast criteria may comprise a broadcast content (e.g., information, tokens, any object that can be broadcasted, etc.), and broadcast conditions. In this example, the broadcast content comprises broadcasting 100 loyalty tokens. The broadcast criteria comprise: (i) customer of first verifying entity 1205; and (ii) older than 21. A request with the airdrop broadcast criteria may be cast through a central entity 1202. In a second operation 1212, the central entity 1202 can lookup users satisfying the broadcast conditions through, for example, the process flow illustrated in FIG. 10. A broadcast (e.g., of digital tokens) service 1203 may require identity verification of one or more avatars of the first verifying entity having an age older than 21. A smart contract on a blockchain may require satisfaction of a predetermined signature weight threshold (e.g., 2) to provide access privileges (e.g., CRUD access) to the predefined attributes data unit 1204 that is off the blockchain. In some instances, a trusted avatar signature may be assigned a weight of 2 and a data store manager signature may be assigned a weight of 1. If the threshold is satisfied (e.g., by providing at least the trusted avatar signature), access to the data unit 1204 may be granted. The data unit 1204 may be looked up to identify the user identifiers which are both verified by the first verifying entity, and have a ‘yes’ value to the ‘older than 21’ column. In a third operation 1213, the broadcast service 1203 may return the identifiers of all users of the system who are customers of the first verifying entity who are older than 21 to the central entity 1202. In a fourth operation, the central entity 1202 may initiate the airdrop of the 100 loyalty tokens across the identified users, such as to an account associated with a first master avatar 1206 and to an account associated with a second master avatar 1207. In some instances, the loyalty token may be evenly distributed (e.g., 50 to two users). In some instances, the broadcast criteria can specify a distribution scheme (e.g., prorated distribution by age of users, etc.).

In some instances, a user may search for another user's broadcasts, such as airdrop broadcast campaigns. In some instances, a user may search for broadcast campaigns from a library of broadcast campaigns, such as by communicating with the central entity 1202, the broadcast service 1203, and/or any other entity that has access to the broadcast campaigns. For example, a customer (e.g., having second master avatar 1207) may be able to search for the broadcast campaign of the merchant 1201. Alternatively or in addition, the merchant 1201 may be able to search for broadcast campaigns of customers (e.g., having first master avatar 1206, having second master avatar 1207, etc.). In some instances, upon the user finding another user's broadcast from the search, the user may initiate a response broadcast to reply to the other user's broadcast, such as in accordance to the methods and process flows described herein.

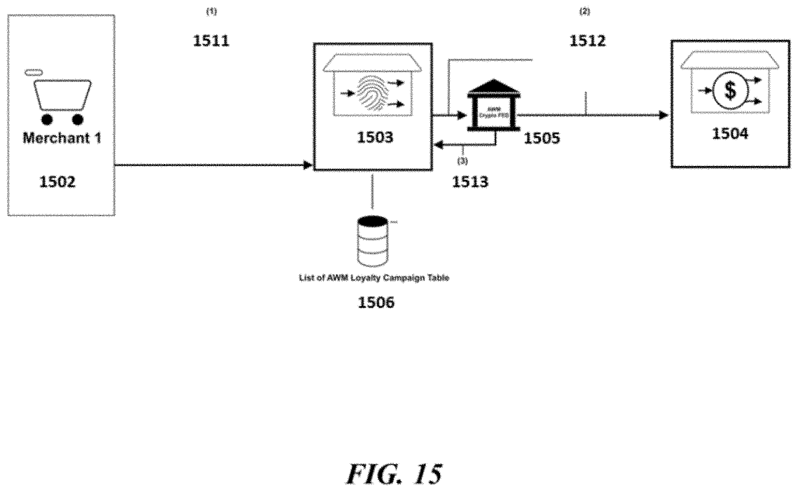

FIGS. 15-17 illustrate example process flows for broadcast searching. FIG. 15 illustrates an example process flow for creating a searchable broadcast. At a first operation 1511, a merchant 1502 can submit an airdrop broadcast to a broadcast service 1503. The airdrop broadcast may comprise a broadcast content and broadcast conditions. In this example, the broadcast content comprises (i) 100 loyalty tokens and (ii) one or more sets of keywords (e.g., “Thai Food”). The broadcast conditions comprise: (i) 10 loyalty tokens per master avatar, and (ii) optionally customers meeting at least a subset of the one or more sets of keywords. In the first operation 1511, the merchant may further stake a buffer token amount, for example, as a certain percentage of the broadcasted loyalty tokens. In this example, 5% of the broadcasted loyalty tokens is staked. In a second operation 1512, the broadcast service 1503 may create the desired amount of loyalty tokens (e.g., 100 loyalty tokens) with a central entity 1505 governing the loyalty tokens, along with a description of the airdrop broadcast. The description may comprise: (i) name (e.g., “Merchant 1”) and (ii) the one or more sets of keywords (e.g., “Thai Food”). The loyalty tokens created may be transferred to a digital wallet 1504 (e.g., campaign wallet) of the merchant 1502. In a third operation 1513, the central entity 1505 may store a record of the airdrop broadcast in a campaign data table 1506. The record of the airdrop broadcast may comprise: (i) broadcast content (e.g., amount of loyalty tokens, keywords, conditions, etc.); (ii) the description (e.g., each description type can be stored as a separate entry); and (iii) digital wallet address of the merchant 1502. The campaign data table 1506 may be searchable by other users, such as through the broadcast service 1503 and/or the central entity 1505. In some instances, the campaign data table 1506 may be searchable by the keywords associated with each record, or any other data entry (e.g., broadcast content, description, digital wallet address, etc.). The campaign data table 1506 may store a plurality of airdrop broadcasts as individual record entries, such as from a plurality of different merchants (or other users).

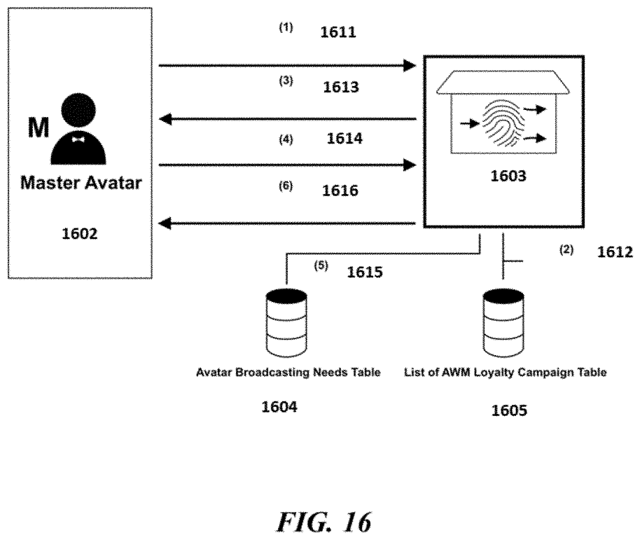

FIG. 16 illustrates an example process flow for searching airdrop broadcasts. At a first operation 1611, a master avatar 1602 associated with a user (e.g., customer) may query a broadcast service 1603 by submitting a search query comprising search conditions. The search conditions may comprise one or more sets of keywords. In this example, the search keywords comprise “Thai Food.” In a second operation 1612, the broadcast service 1603 may search a campaign data table 1605 (e.g., corresponding to the campaign data table 1506) to identify airdrop broadcast records satisfying the user's search conditions (e.g., comprising keywords “Thai Food”). In a third operation 1613, the broadcast service 1603 may provide a list of the identified broadcast records in the campaign data table 1605 to the master avatar 1602. In a fourth operation 1614, the master avatar 1602 may select one or more airdrop broadcasts from the provided list and notify the broadcast service 1603. In a fifth operation 1615, the broadcast service 1603 may store the master avatar 1602's campaign selection in an avatar broadcasting needs data table 1604 as an independent record. The record may comprise, for example, any of the data entries associated with the airdrop broadcast record stored in the campaign data table 1506. In some instances, the record may comprise an address of the master avatar 1602 and/or a date of the master avatar's campaign selection. In some instances, the avatar broadcasting needs data table 1604 may further store broadcasts initiated by the avatars. The broadcasting needs data table 1604 may be searchable by other users (e.g., merchants), such as through the broadcast service 1603 and/or the central entity as described elsewhere herein. In a sixth operation 1616, the broadcast service 1603 may add the selected campaign (e.g., broadcast contents thereof, such as 100 loyalty tokens) to the digital wallet of the master avatar 1602.

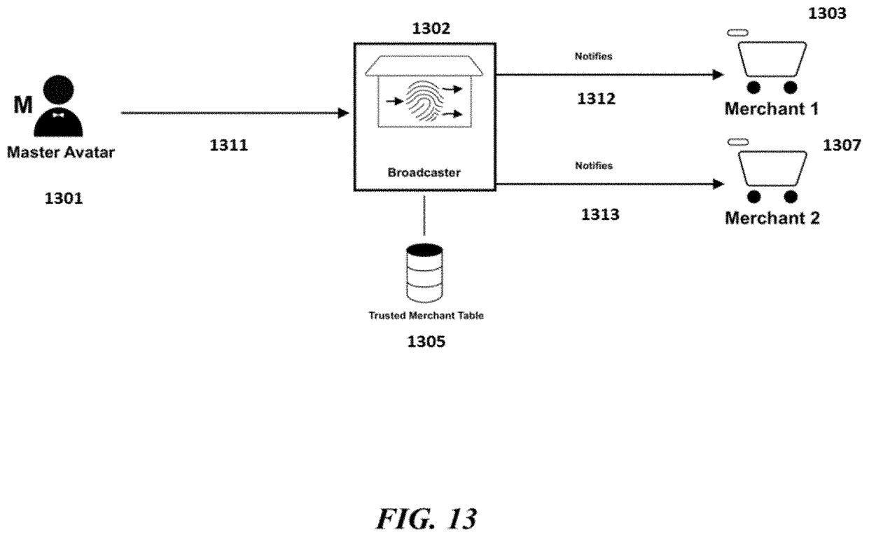

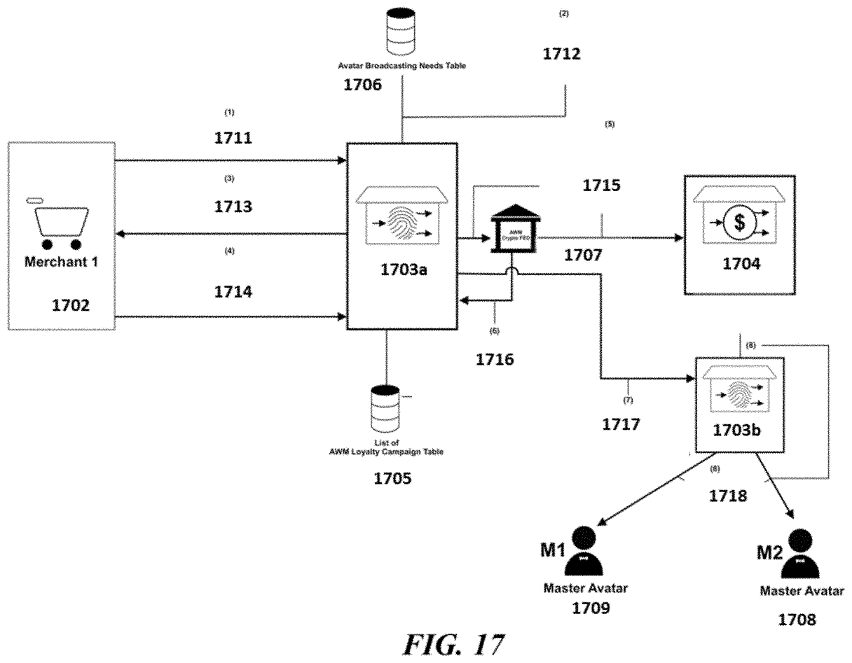

FIG. 17 illustrates a process flow for searching airdrop broadcast needs. At a first operation 1711, a merchant 1702 may query a broadcast service 1703a by submitting a search query comprising search conditions. In some instances, the search conditions may comprise one or more sets of keywords, and/or other conditions, such as dates for broadcasting needs and avatar profiles. In this example, the search conditions comprise the keyword “Thai Food” and dates for broadcasting needs “1/1/2018-3/1/2019.” In some instances, the search conditions may comprise a fulfillment criteria (e.g., on whether or not an avatar has fulfilled a prerequisite requirement). In a second operation 1712, the broadcast service 1703a may search a broadcasting needs data table 1706 (e.g., corresponding to the broadcasting needs data table 1604) for broadcasting needs records satisfying the merchant's search conditions. In a third operation 1713, the broadcast service 1703a may provide a list of the identified broadcasting needs records in the broadcasting needs data table 1706 to the merchant 1702. In a fourth operation 1714, the merchant 1702 may select one or more broadcasting needs from the provided list and notify the broadcast service 1703a. Such notification may be in the form of an existing airdrop broadcast campaign or as a new airdrop broadcast campaign, as described elsewhere herein (e.g., see FIG. 15). In a fifth operation 1715, the broadcast service 1703a may create the desired amount of loyalty tokens (e.g., 100 loyalty tokens) with a central entity 1707 governing the loyalty tokens, along with a description of the airdrop broadcast. The description may comprise: (i) name (e.g., “Merchant 1”) and (ii) the one or more sets of keywords (e.g., “Thai Food”). The loyalty tokens created may be transferred to a digital wallet 1704 (e.g., campaign wallet) of the merchant 1702. In a sixth operation 1716, the central entity 1707 may store a record of the airdrop broadcast in a campaign data table 1706 (e.g., corresponding to the campaign data table 1506, and/or the campaign data table 1605), as described elsewhere herein. In a seventh operation 1717, the broadcast service 1703a may request an airdrop service 1703b to transfer the broadcast content (e.g., 100 loyalty tokens) to selected avatars, such as first avatar 1709 and second avatar 1708. In some instances, the broadcast service 1703a and the airdrop service 1703b may be the same entity. Alternatively, the broadcast service 1703a and the airdrop service 1703b may be independent entities. In operation 1718, upon receipt of the transfer request, the airdrop service 1703b (optionally also with the central entity 1707) may transfer the loyalty tokens from the merchant's digital wallet 1704 to the respective digital wallets of the selected avatars 1708, 1709. For example, of 100 total loyalty tokens to be broadcast in the campaign, between the total of two selected users, each user (e.g., account of avatar associated with each user) may receive 50 loyalty tokens. FIG. 13 illustrates another example of an airdrop process flow using an identity verification platform. In a first operation 1311, a user associated with a master avatar 1301 may initiate a broadcast request to a broadcaster 1302, for example to share a predefined data attribute or identifying information (e.g., “Wants Thai food”) of the user. The broadcast request may comprise a broadcast content and a broadcast criteria. In this example, the broadcast content comprises broadcasting information that master avatar 1301 wants Thai food. The broadcast criteria comprise: (i) merchant of a first verifying entity; and (ii) restaurant. Optionally, the request with the airdrop broadcast criteria may be cast through a central entity (not shown) to the broadcaster 1302. The broadcaster 1302 may lookup users (e.g., merchants) satisfying the broadcast conditions through, for example, the process flow illustrated in FIG. 10. Optionally, a smart contract on a blockchain may require satisfaction of a predetermined signature weight threshold (e.g., 2) to provide access privileges (e.g., CRUD access) to the trusted merchant data unit 1305 that is off the blockchain. If the threshold is satisfied (e.g., by providing at least the trusted avatar signature, by providing the master avatar signature), access to the data unit 1305 may be granted. Alternatively, access to the data unit 1305 may be granted without the threshold. The data unit 1305 may be looked up to identify the user identifiers which are both verified by the first verifying entity, and has a ‘restaurant’ value to a ‘merchant service’ column. In a second and third operation 1312, 1313, which may or may not be simultaneous, the broadcaster 1302 may notify the identified users (e.g., 1303 and 1307, respectively).

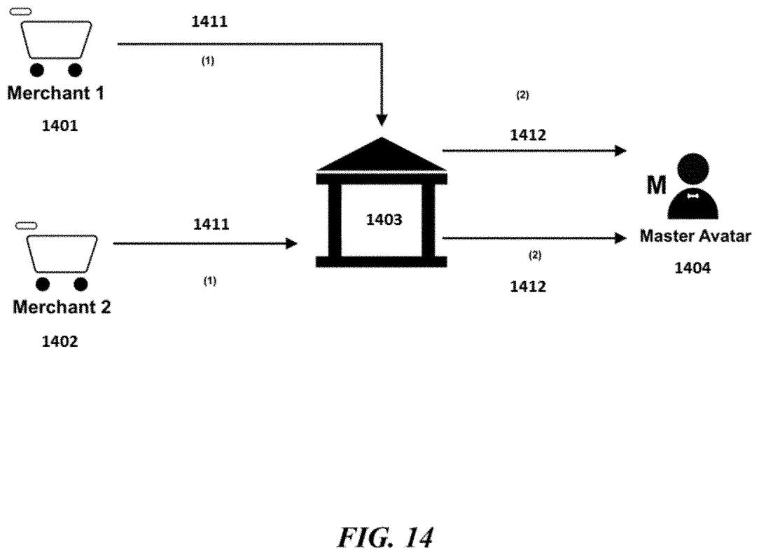

FIG. 14 illustrates another example of an airdrop process flow using an identity verification platform. In some instances, an airdrop broadcast condition may comprise a user's broadcast of a predefined attribute (e.g., “wants Thai food”). For example, each of a first merchant 1401 and a second merchant 1402 may initiate a response broadcast 1411 to a central entity 1403, the response broadcast comprising broadcast content of token distribution. The central entity 1403 may then broadcast 1412 the tokens to an account of the master avatar 1404 that broadcasted the predefined attribute (e.g., “wants Thai food.” In some instances, a merchant's broadcast criteria may comprise ‘users that have broadcasted a first predefined attribute.’ A trusted predefined attributes data unit may comprise corresponding columns, such as “predefined attributes previously broadcasted,” having values corresponding to previously broadcasted data attributes, which may be looked up. For example, in such instances, a process flow similar to that of FIG. 12 may be applied to facilitate identification of the appropriate user pool (e.g., ‘users that have broadcasted a first predefined attribute’) and initiate the token distribution to the user pool.

Such dynamic broadcasting of digital content (e.g., digital tokens, information) between users of the system can beneficially provide a direct avenue for facilitating targeted information outreach. Further, the digital tokens exchanged may allow the incentivization and rewarding of user attention to such information content. In some instances, digital tokens and information may both be broadcasted to a targeted user base, wherein the distributed digital tokens are specifically associated with the information (e.g., where, when, and how the digital tokens may be expended or expires, etc.) that was also broadcasted. A further benefit is that a user may gain significant flexibility over the content that the user wishes to receive (and which the user does not) by, for example, customizing the various predefined data attributes associated with the user's master avatar, and/or selectively broadcasting the user's own preferences (e.g., ‘want Thai food’) to the other users of the system.

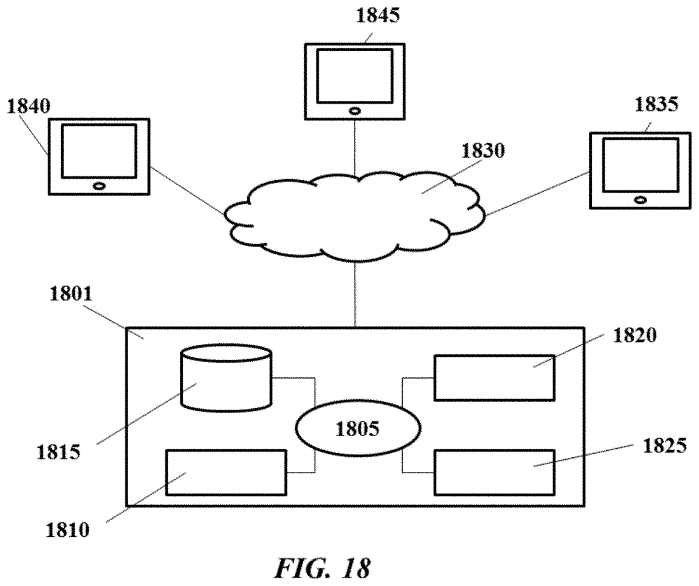

FIG. 18 shows a computer system 1801 that is programmed or otherwise configured to implement methods of the present disclosure. The computer system 1801 can regulate various aspects of identity verification for use in a decentralized network. The computer system 1801 includes a central processing unit (CPU, also “processor” and “computer processor” herein) 1805, which can be a single core or multi core processor, or a plurality of processors for parallel processing. The computer system 1801 also includes memory or memory location 1810 (e.g., random-access memory, read-only memory, flash memory), electronic storage unit 1815 (e.g., hard disk), communication interface 1820 (e.g., network adapter) for communicating with one or more other systems, and peripheral devices 1825, such as cache, other memory, data storage and/or electronic display adapters. The memory 1810, storage unit 1815, interface 1820 and peripheral devices 1825 are in communication with the CPU 1805 through a communication bus (solid lines), such as a motherboard. The storage unit 1815 can be a data storage unit (or data repository) for storing data. The computer system 1801 can be operatively coupled to a computer network (“network”) 1830 with the aid of the communication interface 1820. The network 1830 can be the Internet, an internet and/or extranet, meshnet, or an intranet and/or extranet that is in communication with the Internet. The network 1830 in some cases is a telecommunication and/or data network. The network 1830 can include one or more computer servers, which can enable distributed computing, such as cloud computing. The network 1830, in some cases with the aid of the computer system 1801, can implement a peer-to-peer network, which may enable devices coupled to the computer system 1801 to behave as a client or a server.

The CPU 1805 can execute a sequence of machine-readable instructions, which can be embodied in a program or software. The instructions may be stored in a memory location, such as the memory 1810. The instructions can be directed to the CPU 1805, which can subsequently program or otherwise configure the CPU 1805 to implement methods of the present disclosure. Examples of operations performed by the CPU 1805 can include fetch, decode, execute, and writeback.

The CPU 1805 can be part of a circuit, such as an integrated circuit. One or more other components of the system 1801 can be included in the circuit. In some cases, the circuit is an application specific integrated circuit (ASIC).

The storage unit 1815 can store files, such as drivers, libraries and saved programs. The storage unit 1815 can store user data, e.g., user preferences and user programs. The computer system 1801 in some cases can include one or more additional data storage units that are external to the computer system 1801, such as located on a remote server that is in communication with the computer system 1801 through an intranet or the Internet.

The computer system 1801 can communicate with one or more remote computer systems through the network 1830. For instance, the computer system 1801 can communicate with a remote computer system of a user (e.g., user device having a user interface). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1801 via the network 1830. For example, the computer system 1801 can communicate with a first user device 1835, a second user device 1840, and a third user device 1845.

Methods as described herein can be implemented by way of machine (e.g., computer processor) executable code stored on an electronic storage location of the computer system 1801, such as, for example, on the memory 1810 or electronic storage unit 1815. The machine executable or machine readable code can be provided in the form of software. During use, the code can be executed by the processor 1805. In some cases, the code can be retrieved from the storage unit 1815 and stored on the memory 1810 for ready access by the processor 1805. In some situations, the electronic storage unit 1815 can be precluded, and machine-executable instructions are stored on memory 1810.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1801 can include or be in communication with an electronic display that comprises a user interface (UI) for providing, for example, QR codes, transaction information, fund transfer information, and/or other details. Examples of UI's include, without limitation, a graphical user interface (GUI) and web-based user interface. The electronic display can be integrated or in a user device (e.g., 1835, 1840, 1845). The electronic display can be external to a user device and in communication via wireless or wired connections to the user device. Methods and systems of the present disclosure can be implemented by way of one or more algorithms. An algorithm can be implemented by way of software upon execution by the central processing unit 1805.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1-23. (canceled)

24. A method for facilitating identity verification using a decentralized network, comprising:
(a) receiving from a first user, at a server in communication with a blockchain network, a broadcast request, wherein said broadcast request comprises a (i) broadcast content, and (ii) a broadcast criteria for recipients of said broadcast request, wherein said blockchain network comprises a smart contract, said smart contract managing access rights to a trusted data store, wherein said trusted data store comprises a plurality of predefined data attributes associated with a plurality of users, and wherein said broadcast criteria comprises a first predefined data attribute of said plurality of predefined data attributes;
(b) requesting, by said server, access to said trusted data store by satisfying said smart contract to identify a subset of one or more users of said plurality of users, wherein each user of said subset comprises said first predefined data attribute and satisfies said broadcast criteria;
(c) receiving, by said server, identifiers of each user of said subset of one or more users; and
(d) broadcasting said broadcast content to said subset of one or more users.

25. The method of claim 24, wherein said broadcast content comprises a digital token.

26. The method of claim 24, wherein said broadcast content comprises information.

27. The method of claim 24, wherein one or more data attributes of said plurality of predefined data attributes has been verified by a verifying entity.

28. The method of claim 27, wherein said verifying entity is a financial institution in which the plurality of users holds an account.

29. The method of claim 27, wherein said verifying entity is an authoritative entity.

30. The method of claim 24, wherein said first predefined data attribute comprises an age of a user.

31. The method of claim 24, wherein said access rights comprise rights selected from the group consisting of create, read, update, delete, and copy rights.

32. The method of claim 24, wherein said smart contract comprises one or more conditions to process a transaction on said blockchain network.

33. The method of claim 32, wherein said one or more conditions comprises satisfying a predetermined signature weight threshold.

34. The method of claim 24, further comprising (i) storing said broadcast request in a library database comprising a plurality of broadcast requests, (ii) searching said library database, by a second user, and (iii) selecting said broadcast request from said plurality of broadcast requests.

35. The method of claim 34, further comprising initiating, by said second user, a return broadcast to said first user.

36. The method of claim 34, further comprising, storing a record of said second user selecting said broadcast request in a broadcasting needs data table as an independent record, wherein said broadcasting needs data table is searchable by other users.

37. The method of claim 36, further comprising (i) receiving a search query from a third user to search said broadcasting needs data table, (ii) providing a list of broadcasting needs records identified based on said search query to said third user, (iii) receiving, from said third user, a selection of a given broadcasting need from said list, and (iii) processing an additional broadcast request generated in response to said selection of said given broadcasting need, from said third user to broadcast an additional broadcast content.

38. The method of claim 37 wherein said search query comprises a keyword and a data range.

39. The method of claim 24, wherein said broadcast criteria comprises a user that has broadcasted of said first predefined data attribute.

40. A system for facilitating identity verification using a decentralized network, comprising:
a blockchain network comprising a smart contract, said smart contract managing access rights to a trusted data store, wherein said trusted data store comprises a plurality of predefined data attributes associated with a plurality of users; and
a server in communication with said blockchain network, wherein said server comprises one or more processors operably coupled to a memory comprising instructions, wherein said one or more processors are, individually or collectively, configured to:
(a) receive from a first user, at said server, a broadcast request, wherein said broadcast request comprises a (i) broadcast content, and (ii) a broadcast criteria for recipients of said broadcast request, wherein said broadcast criteria comprises a first predefined data attribute of said plurality of predefined data attributes;
(b) request, by said server, access to said trusted data store by satisfying said smart contract to identify a subset of one or more users of said plurality of users, wherein each user of said subset comprises said first predefined data attribute and satisfies said broadcast criteria;
(c) receive, by said server, identifiers of each user of said subset of one or more users; and
(d) broadcast said broadcast content to said subset of one or more users.

41. The system of claim 40, wherein said broadcast content comprises a digital token.

42. The system of claim 40, wherein said broadcast content comprises information.

43. The system of claim 40, wherein said smart contract comprises one or more conditions to process a transaction on said blockchain network.
